(19) United States
(12) Patent Application Publication
(10) Pub. No.: US 2025/0005396 A1
(43) Pub. Date: Jan. 2, 2025

(54) DYNAMIC BENCHMARKS OF AN INTELLIGENT WORKFLOW

(71) Applicant: INTERNATIONAL BUSINESS MACHINES CORPORATION, Armonk, NY (US)

(72) Inventors: Michael Jack MARTINE, Chapel Hill, NC (US); Sarah Diane GREEN, Chandler, AZ (US); Mark J. LUDLOW, Fairfield, CT (US); Ira L. ALLEN, Dallas, TX (US); Stan Kevin DALEY, Espanola, NM (US)

(21) Appl. No.: 18/344,938

(22) Filed: Jun. 30, 2023

(51) Int. Cl. G06N 5/04; G06F 11/34

(52) U.S. Cl. CPC G06N 5/04; G06F 11/3428

(57) ABSTRACT

A set of benchmarks is determined for a course of action defined for an entity. Data is obtained from one or more exogenous sources. Based on the obtained data and using at least one artificial intelligence agent, one or more benchmarks are evaluated. Based on the evaluation, the set of benchmarks is optimized to obtain a revised set of benchmarks. The revised set of benchmarks is output to be used to evaluate one or more components of the course of action. The obtaining, evaluating, optimizing and outputting are repeated at a plurality of selected times to optimize the revised set of benchmarks. The revised set of benchmarks dynamically changes over the plurality of selected times as the course of action evolves over time.

### BACKGROUND

One or more aspects relate, in general, to dynamic processing within a computing environment, and in particular, to improving such processing.

Processing of a computing environment, as well as other processing, activities or tasks, may be evaluated against benchmarks. A benchmark provides a standard by which the process, activity or task may be evaluated. Based on evaluation of the process, activity or task, improvements may be made.

### SUMMARY

Shortcomings of the prior art are overcome, and additional advantages are provided through the provision of a computer-implemented method of dynamic processing within a computing environment. The computer-implemented method includes determining a set of benchmarks for a course of action defined for an entity. Data is obtained from one or more exogenous sources relating to environmental conditions. Based, at least, on the data obtained from the one or more exogenous sources, one or more benchmarks of the set of benchmarks are evaluated, using at least one artificial intelligence agent executing on at least one computing device of the computing environment. Based on the evaluating the one or more benchmarks, the set of benchmarks is optimized, using the at least one artificial intelligence agent, to obtain a revised set of benchmarks. The revised set of benchmarks is output to be used to evaluate one or more components of the course of action defined for the entity. The obtaining, the evaluating, the optimizing and the outputting are repeated at a plurality of selected times to optimize the revised set of benchmarks. The set of benchmarks for the repeating is the revised set of benchmarks, and the revised set of benchmarks dynamically changes over the plurality of selected times as the course of action evolves over time.

By repeatedly evaluating the benchmarks, optimizations are performed in order to maintain pace with a dynamically changing course of action. Use of storage and computer resources is improved by optimizing the set of benchmarks, and, for instance, not performing benchmarks that are no longer useful.

In one embodiment, the revised set of benchmarks dynamically changes over the plurality of selected times as the course of action and exogenous conditions evolve over time.

In one or more embodiments, the at least one artificial intelligence agent is trained for the course of action defined for the entity. By training the at least one artificial intelligence agent, retrieval and processing of the data is improved. The at least one artificial intelligence agent learns what data of vast amounts of data is to be analyzed for use in optimizing the set of benchmarks. Large amounts of data may be initially considered but then reduced to more relevant data for analysis.

In one or more embodiments, the at least one artificial intelligence agent is retrained based on feedback relating to the set of benchmarks. The retraining facilitates processing within the one or more computing devices by eliminating retrieval, transmission and processing of irrelevant data and enabling the artificial intelligence agent to focus on the most relevant data for analysis. Communication paths within the computing environment are improved by reducing network traffic.

In one or more embodiments, a benchmark is used to measure effectiveness of a component of the one or more components of the course of action. The component includes one or more tasks to be performed to implement the course of action defined for the entity. Use of a benchmark facilitates processing by measuring how successful a component of the course of action is enabling different tasks to be performed, earlier on, based on the benchmark. Processing is improved by tailoring the processing and use of the computer resources to tasks that facilitate implementation of the course of action defined for the entity.

In one or more embodiments, the obtaining data from the one or more exogenous sources includes retrieving, via one or more communication networks, data relating to one or more current exogenous conditions. Use of communication networks to obtain data from exogenous sources enables real-time analysis of the data and use of the data to evaluate the one or more benchmarks, enabling the set of benchmarks to be dynamic and keep pace with a dynamically changing course of action. Further, use of the one or more communications networks facilitates access and transmission of the data.

In one or more embodiments, the optimizing the set of benchmarks includes adding a new benchmark to the set of benchmarks. The addition of a new benchmark provides dynamicity to the set of benchmarks improving processing within the computing environment.

In one or more embodiments, the optimizing the set of benchmarks includes deleting a benchmark from the set of benchmarks. The deletion of a benchmark facilitates processing by eliminating processing cycles that would be performing work that is no longer useful. Those processing cycles are available for other processing, improving processing within the computing environment. Additionally, or alternatively, the use of storage is reduced, as well as processing associated therewith.

In one or more embodiments, the optimizing the set of benchmarks includes modifying a benchmark of the set of benchmarks. Modification of a benchmark improves processing by using processing cycles on more appropriate work and by reducing the use of processing cycles and/or storage/memory on parts of the benchmark no longer as useful.

In one or more embodiments, the optimizing the set of benchmarks includes modifying one or more benchmarks of the set of benchmarks, deleting one or more benchmarks of the set of benchmarks and/or adding one or more benchmarks to the set of benchmarks.

In one or more embodiments, the obtaining the data, the evaluating the one or more benchmarks, and the optimizing the set of benchmarks are executed as part of an intelligent workflow generated to implement the course of action defined for the entity. The use of an intelligent workflow to encapsulate the activities (e.g., the obtaining the data, the evaluating the one or more benchmarks and the optimizing the set of benchmarks) improves retrieval, transmission and processing of data within the computing environment. A multi-dynamic, recursive path is provided to implement the course of action defined for the entity.

In one or more embodiments, using the at least one artificial intelligence agent, analysis is performed to identify deficiencies in one or more processes of the entity. Using the at least one artificial intelligence agent, one or more modifications to the one or more processes are provided to improve use of resources of the entity. By identifying deficiencies within processing, those deficiencies may be addressed enabling improvement in the use of resources.

In one or more embodiments, the resources of the entity include computer resources of the entity, and the one or more modifications improve processing speed within one or more computing devices of the computing environment. This improves processing within the computing devices, as well as the computing environment.

In one or more embodiments, the obtaining the data, the evaluating the one or more benchmarks, the optimizing the set of benchmarks, the performing analysis and the providing the one or more modifications are executed as part of an intelligent workflow generated to implement the course of action defined for the entity. The use of an intelligent workflow to encapsulate the activities (e.g., the obtaining the data, the evaluating the one or more benchmarks, the optimizing the set of benchmarks, the performing analysis and the providing the one or more modifications) improves retrieval, transmission and processing of data within the computing environment. A multi-dynamic, recursive path is provided to implement the course of action defined for the entity.

In one or more embodiments, historical data relating to the course of action defined for the entity is obtained and the evaluating uses the historical data and the data obtained from the one or more exogenous sources. Use of historical data provides advantages in analysis and predictions reducing waste in processing and processing cycles and providing a broader view of the current conditions.

In accordance with one or more aspects, each of the embodiments is separable and optional from one another. Further, embodiments may be combined with one another.

In one aspect, a computer system for dynamic processing within a computing environment is provided. The computer system includes a memory, and one or more computing devices in communication with the memory. The computer system is configured to perform a method. The method includes determining a set of benchmarks for a course of action defined for an entity. Data is obtained from one or more exogenous sources relating to environmental conditions. Based, at least, on the data obtained from the one or more exogenous sources, one or more benchmarks of the set of benchmarks are evaluated, using at least one artificial intelligence agent executing on at least one computing device of the computing environment. Based on the evaluating the one or more benchmarks, the set of benchmarks is optimized, using the at least one artificial intelligence agent, to obtain a revised set of benchmarks. The revised set of benchmarks is output to be used to evaluate one or more components of the course of action defined for the entity. The obtaining, the evaluating, the optimizing and the outputting are repeated at a plurality of selected times to optimize the revised set of benchmarks. The set of benchmarks for the repeating is the revised set of benchmarks, and the revised set of benchmarks dynamically changes over the plurality of selected times as the course of action evolves over time.

By repeatedly evaluating the benchmarks, optimizations are performed in order to maintain pace with a dynamically changing course of action. Use of storage and computer resources is improved by optimizing the set of benchmarks, and, for instance, not performing benchmarks that are no longer useful.

In one embodiment, the revised set of benchmarks dynamically changes over the plurality of selected times as the course of action and exogenous conditions evolve over time.

In one or more embodiments, the obtaining the data, the evaluating the one or more benchmarks, and the optimizing the set of benchmarks are executed as part of an intelligent workflow generated to implement the course of action defined for the entity. The use of an intelligent workflow to encapsulate the activities (e.g., the obtaining the data, the evaluating the one or more benchmarks, and the optimizing the set of benchmarks) improves retrieval, transmission and processing of data within the computing environment. A multi-dynamic, recursive path is provided to implement the course of action defined for the entity.

In one or more embodiments, using the at least one artificial intelligence agent, analysis is performed to identify deficiencies in one or more processes of the entity. Using the at least one artificial intelligence agent, one or more modifications to the one or more processes are provided to improve use of resources of the entity. By identifying deficiencies within processing those deficiencies may be addressed enabling improvement in the use of resources.

In accordance with one or more aspects, each of the embodiments is separable and optional from one another. Further, embodiments may be combined with one another. Yet further, in one or more aspects, each of the embodiments of the computer-implemented method may be embodiments of the computer system and/or is combinable with aspects and/or embodiments of the computer system.

In one aspect, a computer program product for facilitating processing within a computing environment is provided. The computer program product includes one or more computer readable storage media and program instructions collectively stored on the one or more computer readable storage media readable by at least one processing circuit to determine a set of benchmarks for a course of action defined for an entity. The program instructions collectively stored on the one or more computer readable storage media are further readable by the at least one processing circuit to obtain data from one or more exogenous sources relating to environmental conditions, and based, at least, on the data obtained from the one or more exogenous sources, evaluate, using at least one artificial intelligence agent executing on at least one computing device of the computing environment, one or more benchmarks of the set of benchmarks. The program instructions collectively stored on the one or more computer readable storage media are further readable by the at least one processing circuit to optimize, using the at least one artificial intelligence agent, the set of benchmarks, based on the evaluating the one or more benchmarks, to obtain a revised set of benchmarks. The program instructions collectively stored on the one or more computer readable storage media are further readable by the at least one processing circuit to output the revised set of benchmarks to be used to evaluate one or more components of the course of action defined for the entity. The program instructions collectively stored on the one or more computer readable storage media are further readable by the at least one processing circuit to repeat obtaining, evaluating, optimizing and outputting at a plurality of selected times to optimize the revised set of benchmarks. The set of benchmarks for the repeating is the revised set of benchmarks, and the revised set of benchmarks dynamically change over the plurality of selected times as the course of action evolves over time.

By repeatedly evaluating the benchmarks, optimizations are performed in order to maintain pace with a dynamically changing course of action. Use of storage and computer resources is improved by optimizing the set of benchmarks, and, for instance, not performing benchmarks that are no longer useful.

In one embodiment, the revised set of benchmarks dynamically changes over the plurality of selected times as the course of action and exogenous conditions evolve over time.

In one or more embodiments, the program instructions readable by the at least one processing circuit to obtain the data, evaluate the one or more benchmarks, and optimize the set of benchmarks are executed as part of an intelligent workflow generated to implement the course of action defined for the entity. The use of an intelligent workflow to encapsulate the activities (e.g., the obtaining the data, the evaluating the one or more benchmarks and the optimizing the set of benchmarks) improves retrieval, transmission and processing of data within the computing environment. A multi-dynamic, recursive path is provided to implement the course of action defined for the entity.

In one or more embodiments, the program instructions are further readable by the at least one processing circuit to perform analysis, using the at least one artificial intelligence agent, to identify deficiencies in one or more processes of the entity, and provide, using the at least one artificial intelligence agent, one or more modifications to the one or more processes to improve use of resources of the entity. By identifying deficiencies within processing those deficiencies may be addressed enabling improvement in the use of resources.

In one or more embodiments, the program instructions are further readable by the at least one processing circuit to obtain historical data relating to the course of action defined for the entity. The program instructions readable by the at least one processing circuit to evaluate further include program instructions readable by the at least one processing circuit to use the historical data and the data obtained from the one or more exogenous sources. Use of historical data provides advantages in analysis and predictions reducing waste in processing and processing cycles and providing a broader view of the current conditions.

In accordance with one or more aspects, each of the embodiments is separable and optional from one another. Further, embodiments may be combined with one another. Yet further, in one or more aspects, each of the embodiments of the computer-implemented method may be embodiments of the computer program product and/or is combinable with aspects and/or embodiments of the computer program product.

In one aspect, a computer-implemented method of dynamic processing within a computing environment is provided. The computer-implemented method includes executing an intelligent workflow to implement a course of action defined for an entity. The executing includes determining a set of benchmarks for the course of action defined for the entity and obtaining data to be used in evaluating the set of benchmarks. The executing further includes evaluating, using at least one artificial intelligence agent executing on at least one computing device of the computing environment, one or more benchmarks of the set of benchmarks based, at least, on the data obtained from the one or more exogenous sources. The executing further includes optimizing, using the at least one artificial intelligence agent, the set of benchmarks, based on the evaluating the one or more benchmarks, to obtain a revised set of benchmarks. The executing further includes outputting the revised set of benchmarks to be used to evaluate one or more components of the course of action defined for the entity. The executing further includes repeating the obtaining, the evaluating, the optimizing and the outputting at a plurality of selected times to optimize the revised set of benchmarks. The set of benchmarks for the repeating is the revised set of benchmarks, and the revised set of benchmarks dynamically change over the plurality of selected times as the course of action evolves over time.

The use of an intelligent workflow to encapsulate the activities (e.g., the determining, the obtaining the data, the evaluating the one or more benchmarks, the optimizing the set of benchmarks, the outputting and the repeating) improves retrieval, transmission and processing of data within the computing environment. A multi-dynamic, recursive path is provided to implement the course of action defined for the entity. Further, by repeatedly evaluating the benchmarks, optimizations are performed in order to maintain pace with a dynamically changing course of action. Use of storage and computer resources is improved by not performing benchmarks that are no longer useful.

In one embodiment, the revised set of benchmarks dynamically changes over the plurality of selected times as the course of action and exogenous conditions evolve over time.

In one or more embodiments, the executing the intelligent workflow further includes performing analysis, using the at least one artificial intelligence agent, to identify deficiencies in one or more processes of the entity, and providing, using the at least one artificial intelligence agent, one or more modifications to the one or more processes to improve use of resources of the entity. By identifying deficiencies within processing those deficiencies may be addressed enabling improvement in the use of resources.

In one or more embodiments, the executing the intelligent workflow further includes obtaining feedback relating to implementation of the course of action and performing one or more actions based on the feedback to revise the intelligent workflow. Using the feedback to revise the intelligent workflow improves processing by tailoring the processing based on the feedback, conserving processing cycles and/or storage/memory.

In one or more embodiments, the performing the one or more actions includes optimizing the set of benchmarks. Optimization of a benchmark improves processing by using processing cycles on more appropriate work and reducing the use of processing cycles, storage/memory on benchmarks (or parts thereof) no longer as useful.

In accordance with one or more aspects, each of the embodiments is separable and optional from one another.

In one aspect, a computer program product for facilitating processing within a computing environment is provided. The computer program product includes one or more computer readable storage media and program instructions collectively stored on the one or more computer readable storage media readable by at least one processing circuit to execute an intelligent workflow to implement a course of action defined for an entity. Execution of the intelligent workflow includes determining a set of benchmarks for the course of action defined for the entity. Execution of the intelligent workflow further includes obtaining data to be used in evaluating the set of benchmarks, and based, at least on the data obtained from the one or more exogenous sources, evaluating, using at least one artificial intelligence agent executing on at least one computing device of the computing environment, one or more benchmarks of the set of benchmarks based. Execution of the intelligent workflow further includes optimizing, using the at least one artificial intelligence agent, the set of benchmarks, based on the evaluating the one or more benchmarks, to obtain a revised set of benchmarks. Execution of the intelligent workflow further includes outputting the revised set of benchmarks to be used to evaluate one or more components of the course of action defined for the entity. Execution of the intelligent workflow further includes repeating the obtaining, the evaluating, the optimizing and the outputting at a plurality of selected times to optimize the revised set of benchmarks. The set of benchmarks for the repeating is the revised set of benchmarks, and the revised set of benchmarks dynamically changes over the plurality of selected times as the course of action evolves over time.

The use of an intelligent workflow to encapsulate the activities (e.g., the determining, the obtaining the data, the evaluating the one or more benchmarks, the optimizing the set of benchmarks, the outputting and the repeating) improves retrieval, transmission and processing of data within the computing environment. A multi-dynamic, recursive path is provided to implement the course of action defined for the entity. Further, by repeatedly evaluating the benchmarks, optimizations are performed in order to maintain pace with a dynamically changing course of action. Use of storage and computer resources is improved by optimizing the set of benchmarks, and, for instance, not performing benchmarks that are no longer useful.

In one embodiment, the revised set of benchmarks dynamically changes over the plurality of selected times as the course of action and exogenous conditions evolve over time.

In accordance with one or more aspects, each of the embodiments is separable and optional from one another. Further, embodiments may be combined with one another. Yet further, in one or more aspects, each of the embodiments of the computer-implemented method may be embodiments of computer program product and/or is combinable with aspects and/or embodiments of the computer program product.

Computer-implemented methods, systems and computer program products relating to one or more aspects are described and claimed herein. Further, services relating to one or more aspects are also described and may be claimed herein.

Additional features and advantages are realized through the techniques described herein. Other embodiments and aspects are described in detail herein and are considered a part of the claimed aspects.

### BRIEF DESCRIPTION OF THE DRAWINGS

One or more aspects are particularly pointed out and distinctly claimed as examples in the claims at the conclusion of the specification. The foregoing and objects, features, and advantages of one or more aspects are apparent from the following detailed description taken in conjunction with the accompanying drawings in which:

FIG. 1 depicts one example of a computing environment to perform, include and/or use one or more aspects of the present disclosure;

FIG. 2A depicts one example of sub-modules of an intelligent workflow module of FIG. 1, in accordance with one or more aspects of the present disclosure;

FIG. 2B depicts one example of a generate workflow sub-module of FIG. 2A, in accordance with one or more aspects of the present disclosure;

FIG. 2C depicts one example of an execute workflow sub-module of FIG. 2A, in accordance with one or more aspects of the present disclosure;

FIG. 3 depicts one example of processing related to an intelligent workflow, in accordance with one or more aspects of the present disclosure;

FIG. 4 depicts one example of optimizing benchmarks as part of an intelligent workflow, in accordance with one or more aspects of the present disclosure;

FIG. 5 depicts one example of an intelligent workflow, in accordance with one or more aspects of the present disclosure;

FIG. 6 depicts one example of artificial intelligence modeling, in accordance with one or more aspects of the present disclosure;

FIG. 7 depicts one example of processing of an artificial intelligence agent used by the intelligent workflow of FIG. 5, in accordance with one or more aspects of the present disclosure; and

FIG. 8 depicts one example of a machine learning training system used in accordance with one or more aspects of the present disclosure.

### DETAILED DESCRIPTION

In one or more aspects, a capability is provided to facilitate processing within a computing environment and/or to impact functioning of one or more computing devices within the computing environment. In one or more aspects, a computing environment is improved by the selective retrieval, transmission and processing of data (e.g., based on vast amounts of data from a plurality of sources, including exogenous sources) to perform a specific task (e.g., define and execute a plurality of paths to implement a dynamically changing course of action defined for a given entity). Communication paths with the computing environment, including communication networks, are used to access the data to be processed by the computing devices. Systems and data repositories are connected to streamline communication channels and to facilitate access to, retrieval and processing of data by the computing devices.

In one or more aspects, the computing devices use artificial intelligence (e.g., execute at least one artificial intelligence agent) to improve the retrieval, transmission and/or processing of data. Artificial intelligence includes machine learning, which further includes deep learning comprised of neural networks. In one aspect, artificial intelligence, such as, but not limited to, generative artificial intelligence, generative pre-trained transformer and large language model capabilities, use deep learning models that take raw data and learn to generate statistically probable outputs. Artificial intelligence enables a computing device (e.g., at least one artificial intelligence agent executing on the computing device) to obtain and/or derive information, learn from that information and take specific action to perform a given task, improving processing, including processing within the computing device. Processing capabilities are improved by using communication networks to access a plurality of (e.g., many) exogenous sources to obtain data that is analyzed and used to take action that otherwise may have been missed. Processing speed is improved by eliminating, based on analysis of the vast amount of data, activities, actions, tests, etc. that are deemed ineffective, unnecessary, unsuccessful, etc. but otherwise would have been performed.

For example, in one or more aspects, based on the analysis of the data, a set of benchmarks used to measure effectiveness of one or more components (e.g., one or more sets of tasks to achieve an objective) of the course of action being implemented for the entity are evaluated/re-evaluated over time and optimized based on the evaluation/re-evaluation. As examples, one or more benchmarks are added to the set of benchmarks, deleted from the set of benchmarks and/or modified providing a revised set of benchmarks. By tailoring the set of benchmarks over time for the course of action defined for the entity, rather than using a static set of benchmarks, processing is improved by eliminating wasteful processing. Further, the amount of storage used may be reduced by, for instance, eliminating benchmarks no longer used. Other examples are also possible.

In one or more aspects, artificial intelligence is included in an intelligent workflow. An intelligent workflow is the orchestration of automation, artificial intelligence, analytics, and skills to fundamentally change how work is performed. An intelligent workflow uses, for instance, artificial intelligence to obtain data, including real-time data and/or vast amounts of data, analyze the data and perform action(s). In one or more aspects, an intelligent workflow is generated for a particular entity (e.g., an organization) and during execution, repeatedly (e.g., at selected times, periodically, at fixed intervals, at certain times based on signals indicating one or more defined changes, based on events germane to the execution transpiring, based on a schedule, continuously, continually, etc.) evaluates benchmarks used to evaluate selected components of the course of action identified for the entity, performs monitoring of the entity's environment (e.g., including processes) and/or external environments and takes action(s) to, e.g., optimize use of the benchmarks to implement a dynamically changing course of action defined for the entity.

In one aspect, a computer-implemented method of dynamic processing within a computing environment is provided. The computer-implemented method includes determining a set of benchmarks for a course of action defined for an entity and obtaining data from one or more exogenous sources relating to environmental conditions. Based, at least, on the data obtained from the one or more exogenous sources, one or more benchmarks of the set of benchmarks are evaluated, using at least one artificial intelligence agent executing on at least one computing device of the computing environment. Based on the evaluating the one or more benchmarks, the set of benchmarks is optimized, using the at least one artificial intelligence agent, to obtain a revised set of benchmarks. The revised set of benchmarks is output to be used to evaluate one or more components of the course of action defined for the entity. The obtaining, the evaluating, the optimizing and the outputting are repeated at a plurality of selected times to optimize the revised set of benchmarks. The set of benchmarks for the repeating is the revised set of benchmarks, and the revised set of benchmarks dynamically changes over the plurality of selected times as the course of action evolves over time.

By repeatedly evaluating the benchmarks, optimizations are performed in order to maintain pace with a dynamically changing course of action. Use of storage and computer resources is improved by optimizing the set of benchmarks, and, for instance, not performing benchmarks that are no longer useful.

In one embodiment, the revised set of benchmarks dynamically changes over the plurality of selected times as the course of action and exogenous conditions evolve over time.

Additionally, or alternatively, in one or more embodiments, the at least one artificial intelligence agent is trained for the course of action defined for the entity. By training the at least one artificial intelligence agent, retrieval and processing of the data is improved. The at least one artificial intelligence agent learns what data of vast amounts of data is to be analyzed for use in optimizing the set of benchmarks. Large amounts of data may be initially considered but then reduced to more relevant data for analysis.

Additionally, or alternatively, an embodiment in which the evaluating uses the at least one artificial intelligence agent, and the at least one artificial intelligence agent is trained for the course of action defined for the entity, the evaluating is improved by evaluating based on data obtained from vast amounts of data but reduced to relevant data to obtain the most out of the evaluating. Using the at least one trained artificial intelligence agent improves retrieval and processing of the data. The at least one trained artificial intelligence agent learns what data of vast amounts of data are to be analyzed for use in optimizing the set of benchmarks. Large amounts of data may be initially considered but then reduced to more relevant data for analysis.

Additionally, or alternatively, an embodiment in which the optimizing uses the at least one artificial intelligence agent, and the at least one artificial intelligence agent is trained for the course of action defined for the entity, the optimizing is improved. The at least one trained artificial intelligence agent learns from vast amounts of data what benchmarks may be most appropriate for the course of action defined for the entity. Large amounts of data may be initially considered but then reduced to more relevant data for analysis and selection of benchmarks to be used.

Additionally, or alternatively, in one or more embodiments, the at least one artificial intelligence agent is retrained based on feedback relating to the set of benchmarks. The retraining facilitates processing within the one or more computing devices by eliminating retrieval, transmission and processing of irrelevant data and enabling the artificial intelligence agent to focus on the most relevant data for analysis. Communication paths within the computing environment are improved by reducing network traffic.

Additionally, or alternatively, an embodiment in which the evaluating uses the at least one artificial intelligence agent, and the at least one artificial intelligence agent is trained and/or retrained for the course of action defined for the entity, the evaluating is improved by being able to evaluate based on data obtained from vast amounts of data but reduced to relevant data to obtain the most out of the evaluating. Using the at least one trained and/or retrained artificial intelligence agent improves retrieval and processing of the data. The at least one trained and/or retrained artificial intelligence agent learns what data of vast amounts of data is to be analyzed for use in optimizing the set of benchmarks. Large amounts of data may be initially considered but then reduced to more relevant data for analysis.

Additionally, or alternatively, an embodiment in which the optimizing uses the at least one artificial intelligence agent, and the at least one artificial intelligence agent is trained and/or retrained for the course of action defined for the entity, the optimizing is improved. The at least one trained and/or retrained artificial intelligence agent learns from vast amounts of data what benchmarks may be most appropriate for the course of action defined for the entity. Large amounts of data may be initially considered but then reduced to more relevant data for analysis and selection of benchmarks to be used.

Additionally, or alternatively, in one or more embodiments, a benchmark is used to measure effectiveness of a component of the one or more components of the course of action. The component includes one or more tasks to be performed to implement the course of action defined for the entity. Use of a benchmark facilitates processing by measuring how successful a component of the course of action is enabling different tasks to be performed, earlier on, based on the benchmark. Processing is improved by tailoring the processing and use of the computer resources to tasks that facilitate implementation of the course of action defined for the entity.

Additionally, or alternatively, in one or more embodiments, the obtaining data from the one or more exogenous sources includes retrieving, via one or more communication networks, data relating to one or more current exogenous conditions. Use of communication networks to obtain data from exogenous sources enables real-time analysis of the data and use of the data to evaluate the one or more benchmarks, enabling the set of benchmarks to be dynamic and keep pace with a dynamically changing course of action. Further, use of the one or more communications networks facilitates access and transmission of the data.

Additionally, or alternatively, in one or more embodiments, the optimizing the set of benchmarks includes adding a new benchmark to the set of benchmarks. The addition of a new benchmark provides dynamicity to the set of benchmarks improving processing within the computing environment.

Additionally, or alternatively, in one or more embodiments, the optimizing the set of benchmarks includes deleting a benchmark from the set of benchmarks. The deletion of a benchmark facilitates processing by eliminating processing cycles that would be performing work that is no longer useful. Those processing cycles are available for other processing, improving processing within the computing environment. Additionally, or alternatively, the use of storage is reduced, as well as processing associated therewith.

Additionally, or alternatively, in one or more embodiments, the optimizing the set of benchmarks includes modifying a benchmark of the set of benchmarks. Modification of a benchmark improves processing by using processing cycles on more appropriate work and by reducing the use of processing cycles and/or storage/memory on parts of the benchmark no longer as useful.

Additionally, or alternatively, in one or more embodiments, the optimizing the set of benchmarks includes modifying one or more benchmarks of the set of benchmarks, deleting one or more benchmarks of the set of benchmarks and/or adding one or more benchmarks to the set of benchmarks.

Additionally, or alternatively, in one or more embodiments, the obtaining the data, the evaluating the one or more benchmarks, and the optimizing the set of benchmarks are executed as part of an intelligent workflow generated to implement the course of action defined for the entity. The use of an intelligent workflow to encapsulate the activities (e.g., the obtaining the data, the evaluating the one or more benchmarks and the optimizing the set of benchmarks) improves retrieval, transmission and processing of data within the computing environment. A multi-dynamic, recursive path is provided to implement the course of action defined for the entity.

Additionally, or alternatively, in one or more embodiments, using the at least one artificial intelligence agent, analysis is performed to identify deficiencies in one or more processes of the entity. Using the at least one artificial intelligence agent, one or more modifications to the one or more processes are provided to improve use of resources of the entity. By identifying deficiencies within processing, those deficiencies may be addressed enabling improvement in the use of resources.

Additionally, or alternatively, in one or more embodiments, the resources of the entity include computer resources of the entity, and the one or more modifications improve processing speed within one or more computing devices of the computing environment. This improves processing within the computing devices, as well as the computing environment.

Additionally, or alternatively, in one or more embodiments, the obtaining the data, the evaluating the one or more benchmarks, the optimizing the set of benchmarks, the performing analysis and the providing the one or more modifications are executed as part of an intelligent workflow generated to implement the course of action defined for the entity. The use of an intelligent workflow to encapsulate the activities (e.g., the obtaining the data, the evaluating the one or more benchmarks, the optimizing the set of benchmarks, the performing analysis and the providing the one or more modifications) improves retrieval, transmission and processing of data within the computing environment. A multi-dynamic, recursive path is provided to implement the course of action defined for the entity.

Additionally, or alternatively, in one or more embodiments, historical data relating to the course of action defined for the entity is obtained and the evaluating uses the historical data and the data obtained from the one or more exogenous sources. Use of historical data provides advantages in analysis and predictions reducing waste in processing and processing cycles and providing a broader view of the current conditions.

In accordance with one or more aspects, each of the embodiments is separable and optional from one another. Further, embodiments may be combined with one another.

In one aspect, a computer system for dynamic processing within a computing environment is provided. The computer system includes a memory, and one or more computing devices in communication with the memory. The computer system is configured to perform a method. The method includes determining a set of benchmarks for a course of action defined for an entity. Data is obtained from one or more exogenous sources relating to environmental conditions. Based, at least, on the data obtained from the one or more exogenous sources, one or more benchmarks of the set of benchmarks are evaluated, using at least one artificial intelligence agent executing on at least one computing device of the computing environment. Based on the evaluating the one or more benchmarks, the set of benchmarks is optimized, using the at least one artificial intelligence agent, to obtain a revised set of benchmarks. The revised set of benchmarks is output to be used to evaluate one or more components of the course of action defined for the entity. The obtaining, the evaluating, the optimizing and the outputting are repeated at a plurality of selected times to optimize the revised set of benchmarks. The set of benchmarks for the repeating is the revised set of benchmarks, and the revised set of benchmarks dynamically changes over the plurality of selected times as the course of action evolves over time.

By repeatedly evaluating the benchmarks, optimizations are performed in order to maintain pace with a dynamically changing course of action. Use of storage and computer resources is improved by optimizing the set of benchmarks, and, for instance, not performing benchmarks that are no longer useful.

In one embodiment, the revised set of benchmarks dynamically changes over the plurality of selected times as the course of action and exogenous conditions evolve over time.

Additionally, or alternatively, in one or more embodiments, the obtaining the data, the evaluating the one or more benchmarks, and the optimizing the set of benchmarks are executed as part of an intelligent workflow generated to implement the course of action defined for the entity. The use of an intelligent workflow to encapsulate the activities (e.g., the obtaining the data, the evaluating the one or more benchmarks, and the optimizing the set of benchmarks) improves retrieval, transmission and processing of data within the computing environment. A multi-dynamic, recursive path is provided to implement the course of action defined for the entity.

Additionally, or alternatively, in one or more embodiments, using the at least one artificial intelligence agent, analysis is performed to identify deficiencies in one or more processes of the entity. Using the at least one artificial intelligence agent, one or more modifications to the one or more processes are provided to improve use of resources of the entity. By identifying deficiencies within processing those deficiencies may be addressed enabling improvement in the use of resources.

In accordance with one or more aspects, each of the embodiments is separable and optional from one another. Further, embodiments may be combined with one another. Yet further, in one or more aspects, each of the embodiments of the computer-implemented method may be embodiments of the computer system and/or is combinable with aspects and/or embodiments of the computer system.

In one aspect, a computer program product for facilitating processing within a computing environment is provided. The computer program product includes one or more computer readable storage media and program instructions collectively stored on the one or more computer readable storage media readable by at least one processing circuit to determine a set of benchmarks for a course of action defined for an entity. The program instructions collectively stored on the one or more computer readable storage media are further readable by the at least one processing circuit to obtain data from one or more exogenous sources relating to environmental conditions, and based, at least, on the data obtained from the one or more exogenous sources, evaluate, using at least one artificial intelligence agent executing on at least one computing device of the computing environment, one or more benchmarks of the set of benchmarks. The program instructions collectively stored on the one or more computer readable storage media are further readable by the at least one processing circuit to optimize, using the at least one artificial intelligence agent, the set of benchmarks, based on the evaluating the one or more benchmarks, to obtain a revised set of benchmarks. The program instructions collectively stored on the one or more computer readable storage media are further readable by the at least one processing circuit to output the revised set of benchmarks to be used to evaluate one or more components of the course of action defined for the entity. The program instructions collectively stored on the one or more computer readable storage media are further readable by the at least one processing circuit to repeat obtaining, evaluating, optimizing and outputting at a plurality of selected times to optimize the revised set of benchmarks. The set of benchmarks for the repeating is the revised set of benchmarks, and the revised set of benchmarks dynamically change over the plurality of selected times as the course of action evolves over time.

By repeatedly evaluating the benchmarks, optimizations are performed in order to maintain pace with a dynamically changing course of action. Use of storage and computer resources is improved by optimizing the set of benchmarks, and, for instance, not performing benchmarks that are no longer useful.

Additionally, or alternatively, in one or more embodiments, the program instructions readable by the at least one processing circuit to obtain the data, evaluate the one or more benchmarks, and optimize the set of benchmarks are executed as part of an intelligent workflow generated to implement the course of action defined for the entity. The use of an intelligent workflow to encapsulate the activities (e.g., the obtaining the data, the evaluating the one or more benchmarks and the optimizing the set of benchmarks) improves retrieval, transmission and processing of data within the computing environment. A multi-dynamic, recursive path is provided to implement the course of action defined for the entity.

Additionally, or alternatively, in one or more embodiments, the program instructions are further readable by the at least one processing circuit to perform analysis, using the at least one artificial intelligence agent, to identify deficiencies in one or more processes of the entity, and provide, using the at least one artificial intelligence agent, one or more modifications to the one or more processes to improve use of resources of the entity. By identifying deficiencies within processing those deficiencies may be addressed enabling improvement in the use of resources.

Additionally, or alternatively, in one or more embodiments, the program instructions are further readable by the at least one processing circuit to obtain historical data relating to the course of action defined for the entity. The program instructions readable by the at least one processing circuit to evaluate further include program instructions readable by the at least one processing circuit to use the historical data and the data obtained from the one or more exogenous sources. Use of historical data provides advantages in analysis and predictions reducing waste in processing and processing cycles and providing a broader view of the current conditions.

In accordance with one or more aspects, each of the embodiments is separable and optional from one another. Further, embodiments may be combined with one another. Yet further, in one or more aspects, each of the embodiments of the computer-implemented method may be embodiments of the computer program product and/or is combinable with aspects and/or embodiments of the computer program product.

In one aspect, a computer-implemented method of dynamic processing within a computing environment is provided. The computer-implemented method includes executing an intelligent workflow to implement a course of action defined for an entity. The executing includes determining a set of benchmarks for the course of action defined for the entity and obtaining data to be used in evaluating the set of benchmarks. The executing further includes evaluating, using at least one artificial intelligence agent executing on at least one computing device of the computing environment, one or more benchmarks of the set of benchmarks based, at least, on the data obtained from the one or more exogenous sources. The executing further includes optimizing, using the at least one artificial intelligence agent, the set of benchmarks, based on the evaluating the one or more benchmarks, to obtain a revised set of benchmarks. The executing further includes outputting the revised set of benchmarks to be used to evaluate one or more components of the course of action defined for the entity. The executing further includes repeating the obtaining, the evaluating, the optimizing and the outputting at a plurality of selected times to optimize the revised set of benchmarks. The set of benchmarks for the repeating is the revised set of benchmarks, and the revised set of benchmarks dynamically change over the plurality of selected times as the course of action evolves over time.

The use of an intelligent workflow to encapsulate the activities (e.g., the determining, the obtaining the data, the evaluating the one or more benchmarks, the optimizing the set of benchmarks, the outputting and the repeating) improves retrieval, transmission and processing of data within the computing environment. A multi-dynamic, recursive path is provided to implement the course of action defined for the entity. Further, by repeatedly evaluating the benchmarks, optimizations are performed in order to maintain pace with a dynamically changing course of action. Use of storage and computer resources is improved by not performing benchmarks that are no longer useful.

Additionally, or alternatively, in one or more embodiments, the executing further includes performing analysis, using the at least one artificial intelligence agent, to identify deficiencies in one or more processes of the entity, and providing, using the at least one artificial intelligence agent, one or more modifications to the one or more processes to improve use of resources of the entity. By identifying deficiencies within processing those deficiencies may be addressed enabling improvement in the use of resources.

Additionally, or alternatively, in one or more embodiments, the executing further includes obtaining feedback relating to implementation of the course of action and performing one or more actions based on the feedback to revise the intelligent workflow. Using the feedback to revise the intelligent workflow improves processing by tailoring the processing based on the feedback, conserving processing cycles and/or storage/memory.

Additionally, or alternatively, in one or more embodiments, the performing the one or more actions includes optimizing the set of benchmarks. Optimization of a benchmark improves processing by using processing cycles on more appropriate work and reducing the use of processing cycles, storage/memory on benchmarks (or portions thereof) no longer as useful.

In accordance with one or more aspects, each of the embodiments is separable and optional from one another.

In one aspect, a computer program product for facilitating processing within a computing environment is provided. The computer program product includes one or more computer readable storage media and program instructions collectively stored on the one or more computer readable storage media readable by at least one processing circuit to execute an intelligent workflow to implement a course of action defined for an entity. Execution of the intelligent workflow includes determining a set of benchmarks for the course of action defined for the entity. Execution of the intelligent workflow further includes obtaining data to be used in evaluating the set of benchmarks, and based, at least on the data obtained from the one or more exogenous sources, evaluating, using at least one artificial intelligence agent executing on at least one computing device of the computing environment, one or more benchmarks of the set of benchmarks based. Execution of the intelligent workflow further includes optimizing, using the at least one artificial intelligence agent, the set of benchmarks, based on the evaluating the one or more benchmarks, to obtain a revised set of benchmarks. Execution of the intelligent workflow further includes outputting the revised set of benchmarks to be used to evaluate one or more components of the course of action defined for the entity. Execution of the intelligent workflow further includes repeating the obtaining, the evaluating, the optimizing and the outputting at a plurality of selected times to optimize the revised set of benchmarks. The set of benchmarks for the repeating is the revised set of benchmarks, and the revised set of benchmarks dynamically changes over the plurality of selected times as the course of action evolves over time.

The use of an intelligent workflow to encapsulate the activities (e.g., the determining, the obtaining the data, the evaluating the one or more benchmarks, the optimizing the set of benchmarks, the outputting and the repeating) improves retrieval, transmission and processing of data within the computing environment. A multi-dynamic, recursive path is provided to implement the course of action defined for the entity. Further, by repeatedly evaluating the benchmarks, optimizations are performed in order to maintain pace with a dynamically changing course of action. Use of storage and computer resources is improved by optimizing the set of benchmarks, and for instance, not performing benchmarks that are no longer useful.

In one embodiment, the revised set of benchmarks dynamically changes over the plurality of selected times as the course of action and exogenous conditions evolve over time.

In accordance with one or more aspects, each of the embodiments is separable and optional from one another. Further, embodiments may be combined with one another. Yet further, in one or more aspects, each of the embodiments of the computer-implemented method may be embodiments of computer program product and/or is combinable with aspects and/or embodiments of the computer program product.

One or more aspects of the present disclosure are incorporated in, performed and/or used by a computing environment. As examples, the computing environment may be of various architectures and of various types, including, but not limited to: personal computing, client-server, distributed, virtual, emulated, partitioned, non-partitioned, cloud-based, quantum, grid, time-sharing, cluster, peer-to-peer, wearable, mobile, having one node or multiple nodes, having one processor or multiple processors, and/or any other type of environment and/or configuration, etc. that is capable of executing a process (or multiple processes) that, e.g., generates and/or executes an intelligent workflow and/or performs one or more other aspects of the present disclosure, including, but not limited to, dynamically evaluating and optimizing benchmarks. Aspects of the present disclosure are not limited to a particular architecture or environment.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

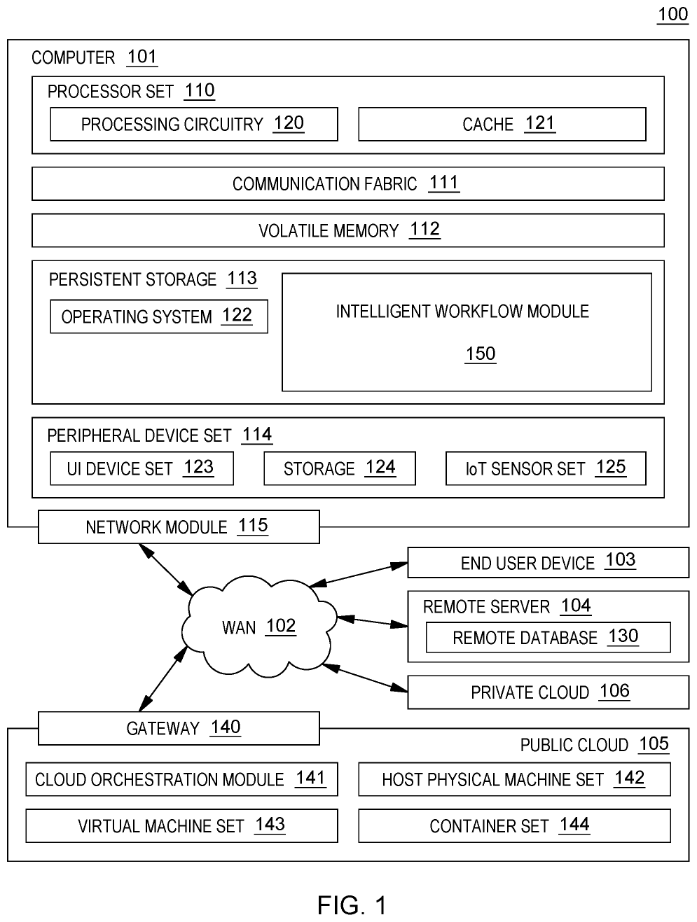

One example of a computing environment to perform, incorporate and/or use one or more aspects of the present disclosure is described with reference to FIG. 1. In one example, a computing environment 100 contains an example of an environment for the execution of at least some of the computer code involved in performing the inventive methods, such as intelligent workflow code or module 150. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The computing environment described above is only one example of a computing environment to incorporate, perform and/or use one or more aspects of the present disclosure. Other examples are possible. For instance, in one or more embodiments, one or more of the components/modules of FIG. 1 are not included in the computing environment and/or are not used for one or more aspects of the present disclosure. Further, in one or more embodiments, additional and/or other components/modules may be used. Other variations are possible.

In one or more aspects, to implement a course of action defined for an entity, one or more benchmarks are used to measure effectiveness of one or more components of the course of action. A component is, for instance, a set of tasks used to implement the course of action, and the effectiveness indicates whether the component is behaving as expected, is successful, etc. A benchmark provides an indication of the effectiveness. For instance, an output of a benchmark may be a rating or value, and if that rating or value is a certain rating or value, within a defined range, or has a predetermined relationship (e.g., greater than, less than, equal, etc.) with a threshold, then the component is deemed effective. The set of benchmarks used is dynamically optimized (e.g., added, deleted, modified), in accordance with one or more aspects, rather than statically set, based on repeatedly evaluating the benchmarks based on obtained data, such as real-time data, other data, etc.

Although the repeated evaluation/optimization of the set of benchmarks is described herein as being performed as part of an intelligent workflow generated to facilitate implementation of the course of action (e.g., the dynamically changing course of action) defined for the entity, in one or more other examples, the repeated evaluation/optimization of the set of benchmarks is performed independent or absent of an intelligent workflow. Many variations are possible.

In one example, to generate and execute an intelligent workflow, an intelligent workflow module (e.g., intelligent workflow module 150) is used, in accordance with one or more aspects of the present disclosure. An intelligent workflow module (e.g., intelligent workflow module 150) includes code or instructions used to generate and execute an intelligent workflow, in accordance with one or more aspects of the present disclosure. An intelligent workflow module (e.g., intelligent workflow module 150) includes, in one example, various sub-modules to be used to generate and execute an intelligent workflow. The sub-modules are, e.g., computer readable program code (e.g., instructions) in computer readable media, e.g., storage (persistent storage 113, storage 124, cache 121, other storage, as examples). The computer readable media may be part of a computer program product and the computer readable program code may be executed by and/or using one or more computing devices (e.g., one or more computers, such as computer(s) 101; one or more end user devices, such as end user device(s) 103; one or more servers, such as server(s) 104; one or more processors or nodes, such as processor(s) or node(s) of processor set 110; processing circuitry, such as processing circuitry of processor set 110; and/or other computing devices, etc.). Additional and/or other computers, servers, devices, processors, nodes, processing circuitry and/or other computing devices may be used to execute one or more of the sub-modules and/or portions thereof. Many examples are possible.

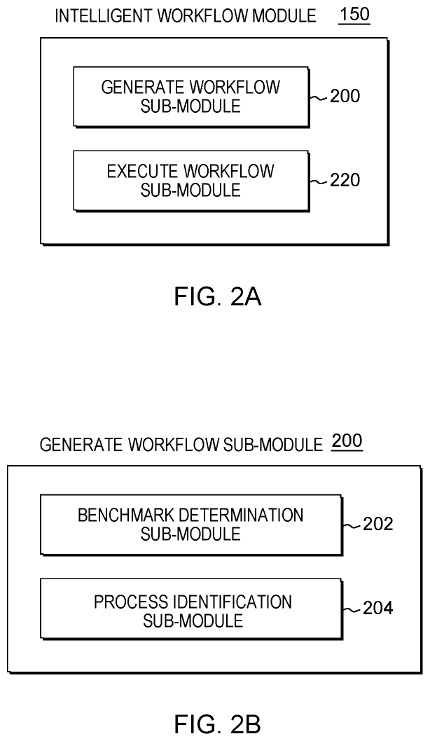

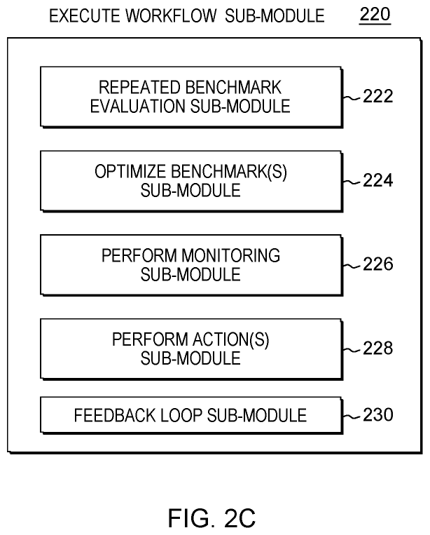

One example of intelligent workflow module 150 is described with reference to FIGS. 2A-2C. In one example, an intelligent workflow module 150 includes, for instance, a generate workflow sub-module 200 used to generate an intelligent workflow, and an execute workflow sub-module 220 used to execute the generated intelligent workflow. Further details relating to generate workflow sub-module 200 are described with reference to FIG. 2B and further details relating to execute workflow sub-module 220 are described with reference to FIG. 2C. Although various sub-modules are described, an intelligent workflow module, such as intelligent workflow module 150, may include additional, fewer and/or different sub-modules. A particular sub-module may include additional code, including code of other sub-modules, less code, and/or different code. Further, additional and/or other modules and/or sub-modules may be used to perform intelligent workflow and/or other aspects of the present disclosure. Many variations are possible.

Referring to FIG. 2B, in one example, generate workflow sub-module 200 includes a benchmark determination sub-module 202 to determine a set (e.g., one or more) benchmarks to be used to measure effectiveness of one or more components of the course of action defined for the entity; and a process identification sub-module 204 to identify one or more processes related to the dynamically changing course of action and/or the entity.

Referring to FIG. 2C, in one example, execute workflow sub-module 220 includes a repeated benchmark evaluation sub-module 222 to repeatedly (e.g., at selected times, periodically, at fixed intervals, at certain times based on signals indicating one or more defined changes, based on events germane to the execution transpiring, based on a schedule, continuously, continually, etc.) evaluate benchmarks; an optimize benchmark(s) sub-module 224 to optimize one or more of the benchmarks based on the evaluations, including, for instance, adding one or more new benchmarks, deleting one or more benchmarks and/or modifying one or more benchmarks; a perform monitoring sub-module 226 to perform monitoring relating to the dynamically changing course of action and/or the entity's environment; a perform action(s) sub-module 228 to perform one or more actions to adjust to the dynamically changing course of action (e.g., optimize a set of benchmarks, such as, for instance, add, delete and/or modify one or more benchmarks; change one or more resources, such as, for instance, add computing resources, delete computing resources and/or revise computing resources of a computing environment of the entity; change one or more processes (e.g., add, delete, revise); change procedures (e.g., add, delete, revise); etc.); and a feedback loop sub-module 230 to repeatedly learn and revise the intelligent workflow, including but not limited to, optimizing one or more benchmarks.

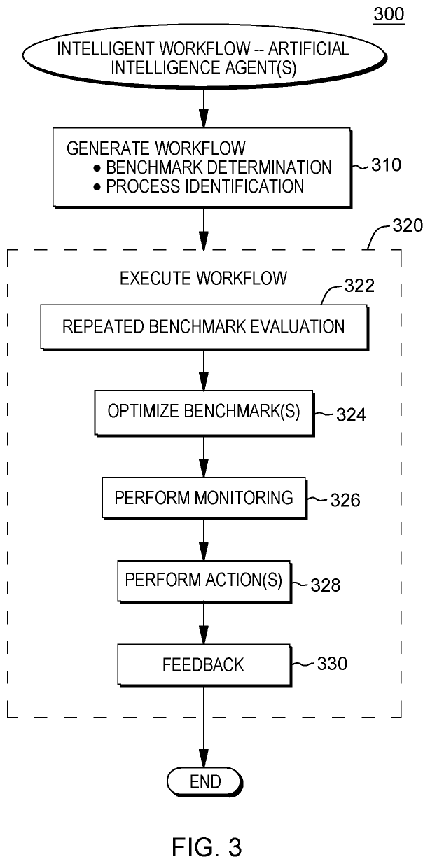

The sub-modules are used, in accordance with one or more aspects of the present disclosure, to generate and execute an intelligent workflow, as further described with reference to FIG. 3. In one example, an intelligent workflow process 300 is executed by one or more computing devices (e.g., one or more computers, such as computer(s) 101; one or more end user devices, such as end user device(s) 103; one or more servers, such as server(s) 104; one or more processors or nodes, such as processor(s) or node(s) of processor set 110; processing circuitry, such as processing circuitry of processor set 110; and/or other computing devices, etc.). Additional and/or other computers, servers, devices, processors, nodes, processing circuitry and/or other computing devices may be used to execute the intelligent workflow process, one or more of the sub-modules and/or portions thereof. Many examples are possible.

In one example, one or more aspects of an intelligent workflow process (e.g., intelligent workflow process 300) uses artificial intelligence to perform a plurality of activities, including, e.g., obtain data from a plurality of sources, including sources internal to the entity and external sources, analyze the data to provide a reduced set of the obtained data, perform actions, such as identify and/or define benchmarks and/or processes, repeatedly evaluate and monitor, perform optimizations based on the repeated evaluation and/or monitoring, and receive feedback to repeatedly learn, re-train, and adapt. As one example, at least one artificial intelligence agent (also referred to herein as agent) is used to perform the various activities. An artificial intelligence agent is, for instance, composed of one or more artificial intelligence models that interact with datasets (e.g., using various communication networks) and with one or more environments to obtain knowledge, use that knowledge to provide an output and to repeatedly refine their knowledge and learn.

An artificial intelligence agent may be executed by one or more computing devices (e.g., one or more computers, such as computer(s) 101; one or more end user devices, such as end user device(s) 103; one or more servers, such as server(s) 104; one or more processors or nodes, such as processor(s) or node(s) of processor set 110; processing circuitry, such as processing circuitry of processor set 110; and/or other computing devices, etc.). Further, an artificial intelligence agent may be incorporated in one or more of intelligent workflow module 150, sub-modules 200-204, 220-230, and/or additional and/or other modules/sub-modules. Additional and/or other computers, servers, devices, processors, nodes, processing circuitry and/or other computing devices may be used to execute the artificial intelligence agent, one or more of the sub-modules and/or portions thereof. Many examples are possible.

Referring to FIG. 3, in one example, intelligent workflow process 300 (also referred to herein as process 300) generates 310 an intelligent workflow (also referred to herein as workflow) to define and execute a plurality of paths to implement a dynamically changing course of action defined for an entity. Generation of the intelligent workflow includes identifying and defining activities and tools to be used to perform the defined task of, e.g., defining and executing a plurality of paths to implement a dynamically changing course of action defined for a given entity. In one example, generation of the intelligent workflow includes determining a set of benchmarks to be used to measure effectiveness of one or more components of the course of action defined for the entity. In one example, the set of benchmarks includes one or more initial benchmarks to be used in evaluating the one or more components.

In one example, the set of benchmarks (e.g., one or more benchmarks) is identified and/or created. The set of benchmarks may include benchmarks typically used by the entity, as well as others that typically would not be considered. For instance, artificial intelligence may be used to expand the view of benchmarks to be defined for the intelligent workflow. As an example, at least one artificial intelligence agent is used to obtain data (e.g., vast amounts and/or data from many different sources), identify relationships from the data that may not have been considered previously and identify benchmarks therefrom.

In one or more aspects, the at least one artificial intelligence agent accesses sources relating to the course of action defined for the entity, the entity's environment and/or other environments external to the entity to retrieve data relating to the entity's environment and/or other factors external to the entity but may affect the entity and/or the course of action defined for the entity. The retrieved data (which includes, e.g., an expanded amount and view of the data based on using exogenous sources and identifying data that might otherwise not be identified) is analyzed to identify relationships in and/or affecting the course of action identified for the entity. The identified relationships are traced over time and compared to one another to determine changes that may be made based on the changing course of action.

In one or more aspects, a set of benchmarks is initially identified and/or created based on the retrieved data (e.g., relationships) and/or selected components of the course of action to be measured. Over time, the set of benchmarks is optimized (e.g., one or more benchmarks are added, deleted and/or modified) to reflect, e.g., the relationships identified over time and/or changes thereto.

In one or more aspects, tracing is performed across relationships and over time. Tracing can be performed from different points and compared to time, providing historical traceability. This tracing may be used to create, evaluate/re-evaluate and/or optimize a set of benchmarks, as described herein.

Further, in one example, the generation of the intelligent workflow includes identifying one or more processes to be used to identify deficiencies in one or more paths taken to implement the dynamically changing course of action and/or in processing within the entity's environment (e.g., computing environment).

In one or more aspects, one or more processes are identified for the course of action and/or the entity's environment. For example, one or more processes are identified that when executed may indicate one or more deficiencies in the entity's environment that may affect implementation of the dynamically changing course of action. For example, analysis may be performed to evaluate whether developers are reusing computer code and/or using existing routines, subroutines, functions, etc. to work efficiently. The analysis ensures, for example, that developers/programmers are using the appropriate patterns when developing program code—e.g., use an existing routine (e.g., sort routine) instead of writing their own; and/or identifies one or more actions that the entity performs that are different than others (e.g., use of particular resources (e.g., computer resources), payroll practice; etc.). Benchmarks may also be identified based on the analysis.

In one example, the analysis is performed using artificial intelligence. For example, one or more artificial intelligence agents may be used to perform the analysis and identification of the processes, as well as the benchmarks.

Based on generating the intelligent workflow (e.g., determining a set of benchmarks and identifying one or more processes), process 300 (e.g., using at least one artificial intelligence agent) executes 320 the intelligent workflow to perform a plurality of activities to facilitate implementation of the dynamically changing course of action defined for the entity. In one example, as part of execution, process 300 repeatedly evaluates 322 the benchmarks. That is, a benchmark is considered fluid instead of static and is evaluated at repeatedly, for instance, selected times (e.g., every x seconds, minutes, hours, etc.; each time one evaluation ends, another begins; within predefined time intervals from a to b; at selected times of the day, week, month, etc.; based on obtaining certain data indicating an evaluation is to be performed as signaled by an artificial intelligence agent; based on events germane to the execution transpiring; based on a schedule; continuously; continually; at fixed intervals; at certain times based on signals indicating one or more defined changes; etc.). Enhancements in technology, environmental conditions, and/or other conditions may be used in evaluating a benchmark and/or trigger a dynamic evaluation of the benchmark(s).

In one example, at least one artificial intelligence agent obtains data (e.g., exogenous data, real-time data, data regarding the entity or course of action, etc.), and based on the data performs the evaluation of the set of benchmarks (e.g., an initial set of one or more benchmarks and/or a revised set of one or more benchmarks).

Based on the evaluation, process 300 optimizes 324 one or more of the benchmarks and outputs a revised set of benchmarks. For instance, process 300 (e.g., using at least one artificial intelligence agent) adds, deletes, and/or modifies one or more benchmarks of the set of benchmarks providing a revised set of benchmarks to facilitate implementation of the course of action defined for the entity. For instance, evaluation may indicate that a benchmark initially used is inappropriate, and therefore, is not to be used any longer and/or that one or more other benchmarks are to be added and/or revised. Optimization of the benchmarks (e.g., the set of benchmarks, whether the initial set of benchmarks or a revised set of benchmarks) enables the benchmarks to change and be used to evaluate the implementation of the course of action as it changes. Benchmarks for other entities may be identified to determine whether they are to be included in evaluating the implementation.

Execution of the workflow also includes, in one example, monitoring one or more aspects related to the course of action defined for the entity and/or the entity's environment. For instance, process 300 performs monitoring 326 (e.g., using at least one artificial intelligence agent) against the benchmarks, course of action and execution paths implementing the course of action, particularly as the course of action evolves. In one or more aspects, the monitoring is highly correlated with the repeated evaluation of the benchmarks. For example, as the course of action changes, the benchmarks are re-evaluated, not only as described above, but to keep pace with the dynamically changing course of action. In one example, the monitoring may indicate that a benchmark is less valuable than initially thought. Based thereon, the benchmark is removed, and a more appropriate benchmark may replace it. This may spur improved activity for implementation of the dynamically changing course of action.

In one or more aspects, scientific methods suggest that evaluation outcomes (e.g., all outcomes) are possible as the hypotheses are exercised via simulation, regression and/or other testing means—not just outright rejection of a benchmark, but also evolution of portions of the data or new exogenous data sources to further reinforce the impact of one benchmark over another.

In one or more aspects, processes of the entity are also monitored and measured, e.g., against the benchmarks. For example, consideration is given to how ecosystem networks operate, which can be n-levels deep. Rarely, does an entity control all elements of supply and demand, and a process change at one level in the hierarchy can have an impact on several levels higher or lower. This understanding of the processes that are impacted by the course of action are further evaluated against the benchmarks on a repeated basis, and through the iterative evolution of the course of action, new and different options may emerge that will have a more significant impact in terms of speed, cost and/or other measurable outcomes. Furthermore, in one or more aspects, executing simulations for resiliency and redundancy makes for a more sustainable process in the long term, and the elements outlined herein can be applied in the same manner to optimize for those process outcomes.

In one or more aspects, as part of execution of the workflow, process 300 performs 328 (e.g., using at least one artificial intelligence agent) one or more action(s) to, e.g., adjust one or more aspects of the intelligent workflow to address the dynamically changing course of action defined for the entity. The one or more actions include, for instance, adding, changing, deleting one or more benchmarks; identifying additional and/or other processes; performing further evaluation of the benchmarks, processes, etc.; retraining the at least one artificial intelligence agent based on lessons learned and/or feedback; and/or other actions to facilitate implementation of a dynamically changing course of action to meet a specified goal (e.g., reach the overall goal specified in/by the course of action).

As an example, the one or more actions selected are based on the repeated benchmark evaluation and/or the monitoring. In one aspect, the at least one artificial intelligence agent obtains data from a plurality of sources, including exogenous sources, internal sources, etc. The data includes one or more of: current market conditions, skill levels, current state of the art of technology, data regarding current benchmarks, data relating to the entity (e.g., performance objectives), aspects relating to the current course of action defined for the entity, supply chain conditions, news events, cost rates, other exogenous data, other data, etc. Based on the data, the at least one artificial intelligence agent performs analysis and makes recommendations regarding the actions to be performed. One or more of the actions may be performed automatically, such as the artificial intelligence agent selects a new benchmark and incorporates it into the intelligent workflow, modifies one or more benchmarks to be used by the intelligent workflow, and/or removes a benchmark from the intelligent workflow. Although example actions are indicated, additional, fewer and/or other actions may be performed.

In one or more aspects, as part of execution of the workflow, process 300 obtains 330 feedback regarding one or more aspects of the intelligent workflow, including one or more benchmarks, to facilitate implementation of the course of action. For example, assuming a given course of action defined for an entity, is it attainable? Intelligent workflows may be used to create space for dynamic alterations that are not constrained by firm, immutable rules. Different pathways may be explored to achieve better results (e.g., a successful (as determined based on one or more thresholds) implementation of a course of action for an entity. The intelligent workflow enables permutations to be considered that otherwise would not be considered. New behaviors and/or activities are exhibited, and thus, new benchmarks and pathways may be determined and/or employed. By re-evaluating, e.g., the benchmarks and being flexible with optimizing one or more benchmarks, changes in an entity's course of action may be accommodated.

In one or more aspects, as part of the feedback, historical data is leveraged to predict future events. This allows for anti-bias assessment against, for instance, a sunk-cost fallacy (i.e., reluctancy to abandon a course of action because an entity has invested heavily in it, even when it is clear that abandonment would be more beneficial) by reviewing the combination of, e.g., benchmarks, course of action and execution. The historical data combined with market considerations and evaluation of change management success, determines wasted motion analysis. Feedback is benefited from historical data, market considerations and evaluation of repeatable execution.

In one or more aspects, history is preserved, and lessons are learned from the past. Visibility into relationships is provided. Relationships are assessed going back and a record of differences is provided. Benchmarks are evaluated against the results, in one example.

In one or more aspects, the feedback, historical data and/or lessons learned are used to retrain the at least one artificial intelligence agent. By retraining the artificial intelligence agent, the agent may make better predictions of the benchmarks to use and how to optimize the set of benchmarks (e.g., initial set and/or a revised set). Retraining also provides other benefits and enhancements to the at least one artificial intelligence agent.

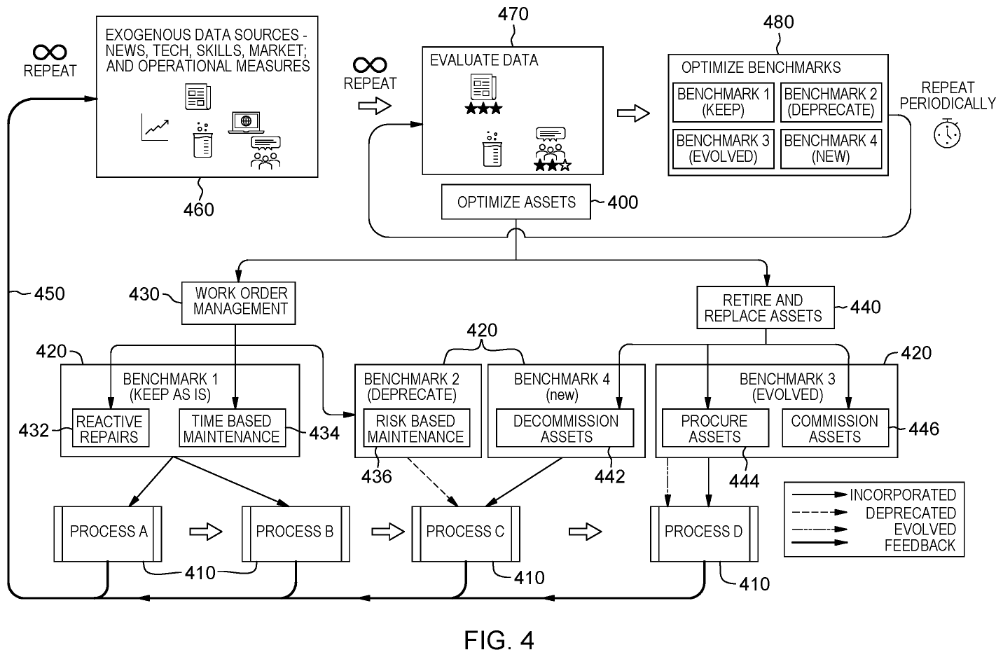

Evaluation and optimization of benchmarks are further described with reference to FIG. 4. In one example, there is a course of action 400 defined and being implemented for an entity. The course of action includes, for example, a plurality of components. In one example, the course of action defined for the entity is to optimize assets (e.g., resources, such as computer resources (e.g., hardware, software, firmware, contracts, licenses, etc.), manufacturing resources (e.g., machines, programs, contracts, licenses, etc.), and/or services provided, etc. Additional, fewer and/or other types of assets may be optimized). The plurality of components is represented as capabilities and/or processes (such as, e.g., processes 410) to be executed to implement the course of action. In one example, one or more benchmarks (e.g., benchmarks 420) are mapped to the processes (e.g., processes 410) to evaluate the processes and guide execution of the processes over time. The benchmarks may be selected from a database of known benchmarks and/or may be custom developed. The development of a benchmark may use one or more tools now known or later developed and/or may be developed without the aid of a tool. Many options are possible.

In one example, one component of course of action 400 is a work order management component 430, in which there may be reactive repairs 432, time based maintenance 434 and/or risk based maintenance 436, as examples; and another component is retire and replace assets component 440, in which one or more assets may be decommissioned 442, procured 444 and/or commissioned 446, as examples. The components described herein are only examples. There may be additional (including many more), fewer and/or other components. Further, the course of action provided herein as an example, is only an example. Many other courses of action may be defined for an entity and executed. Again, many examples are possible.

In this particular example, Benchmark 1 is mapped to Process A and Process B and evaluates reactive repairs 432 and time based maintenance 434 with respect to the processes; Benchmark 2 is mapped, at least initially, to Process C and evaluates risk based maintenance 436; Benchmark 4 becomes mapped to Process C and evaluates decommissioned assets 442; Benchmark 3 is mapped to Process D and evaluates procured assets 444 and commissioned assets 446. Other examples are possible.

As the processes are executed, the benchmarks perform evaluations related to the processes. Data relating to the processes and the benchmarks are fed 450 back to one or more repositories 460. The repositories include sources, including, but not limited to, exogenous sources, that include the data and measures provided from the processes, as well as one or more of: news, technology updates, skills data, market data, operational measures, cost rates, supply chain considerations, other exogenous data, other data, etc. Many types of data from many different sources may be considered.

In one or more aspects, the data is evaluated 470 repeatedly (e.g., at selected times, periodically, at fixed intervals, at certain times based on signals indicating one or more defined changes, based on events germane to the execution transpiring, based on a schedule, continuously, continually, etc.). The evaluated data is used to optimize 480 the benchmarks (e.g., a set of benchmarks). For instance, the optimization is performed at chosen times (e.g., periodically, at fixed intervals, at certain times based on signals indicating one or more defined changes, based on the evaluation, based on a schedule, etc.). Based on the evaluation, the set of benchmarks (e.g., one or more of the benchmarks) is optimized. For instance, based on evaluation at a selected time, Benchmark 1 is kept as is, Benchmark 2 is deprecated (e.g., deleted, no longer used), Benchmark 3 is evolved (e.g., modified), and Benchmark 4 is new. Although example optimizations for benchmarks are provided, additional, fewer and/or other benchmarks may be optimized, and the optimizations may be different than described in this example. For instance, none of the benchmarks may be deprecated or modified, additional benchmarks may be added, and/or none of the benchmarks may be maintained as is. Many variations are possible. The benchmarks are dynamic in that one or more changes may be made in order to address changes made to the course of action defined for the entity and/or based on exogenous changes.

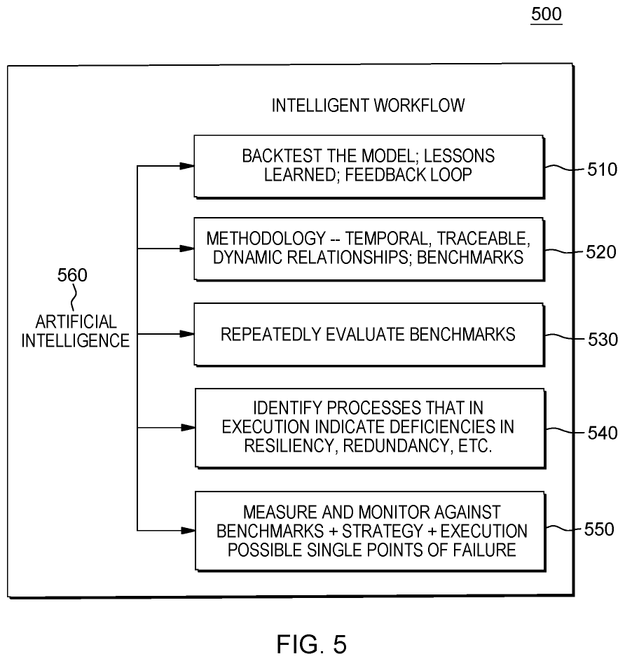

As indicated, in one or more aspects, the benchmarks are included in an intelligent workflow that dynamically changes based on, e.g., changes made to the course of action defined for the entity. One example of an intelligent workflow generated in accordance with one or more aspects of the present disclosure is depicted in FIG. 5. In one example, an intelligent workflow 500 includes the following activities included as part of one intelligent workflow: feedback 510, including, for instance, a backtest of the model (e.g., one or more artificial intelligence models of the at least one artificial intelligence agent), lessons learned, and/or a feedback loop; methodology 520, including, for instance, temporal, traceable, dynamic relationships and/or benchmarks; evaluate 530, including, for instance, repeated evaluation of benchmarks; process identification 540, including, for instance, identify processes that in execution indicate deficiencies in resiliency, redundancy, etc.; and monitor 550, including, for instance, measure and monitor against benchmarks, course of action and execution to define changes to be made and/or determine potential single points of failure.

In one or more aspects, one or more of the activities of the intelligent workflow use artificial intelligence 560 and/or artificial intelligence is used to connect one or more of the activities. As an example, at least one artificial intelligence agent is trained and learns based on input. The at least one artificial intelligence agent is trained and retrained to continually learn. In an example, the at least one artificial intelligence agent includes one or more artificial intelligence models that rely on training data to recognize patterns and make predictions or decisions.

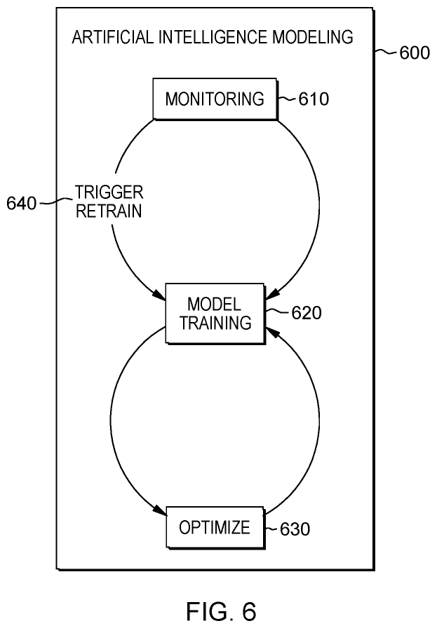

One example of a lifecycle of an artificial intelligence model is described with reference to FIG. 6. In one example, a modeling lifecycle 600 includes, for instance, building and training 620 an artificial intelligence model (of, e.g., at least one artificial intelligence agent). The training is based on, for instance, monitoring 610, data analysis and feedback. Based on repeated monitoring and/or analysis, a retraining 640 of the model may be triggered, providing a fluid, rather than static, model used by the intelligent workflow. Based on the model, optimization 630 is performed. For instance, one or more benchmarks, processes and/or the intelligent workflow may be optimized (e.g., add, modify, delete). Training 620 may further be performed based on the optimization. Further options are possible. The model is used to generate and execute an intelligent workflow that is dynamic and polymorphic.

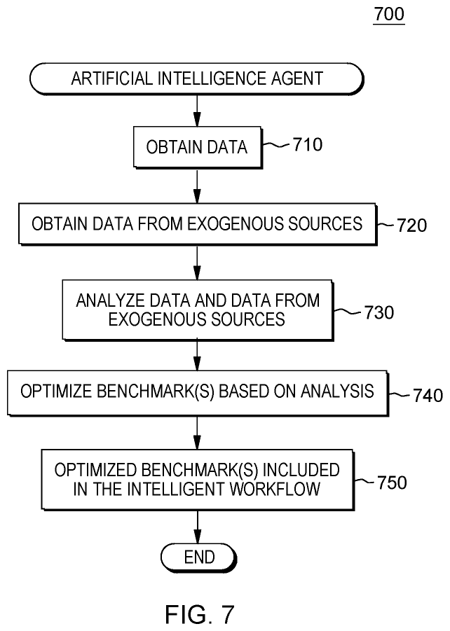

Further details relating to one embodiment of an artificial intelligence agent are described with reference to FIG. 7. In one example, at least one artificial intelligence agent 700 obtains 710 data, such as data related to the entity, the course of action, and existing benchmarks, as well as data 720 from exogenous sources, such as real-time data related to the entity, current events, available benchmarks, information related to other entities, such as benchmarks they use; etc.

Artificial intelligence agent 700 analyzes 730 the data (e.g., the data related to the entity, course of action, existing benchmarks, and data from exogenous sources) to determine whether changes are to be made, such as changes to a set of benchmarks (e.g., one or more benchmarks of a set or revised set of benchmarks). Based on the analysis, the at least one artificial intelligence agent 700 performs optimization 740, such as, for example, optimizes (e.g., adds, deletes and/or modifies) one or more benchmarks. Although in this example, the optimization is performed for the benchmarks, in other examples, additional and/or other optimizations may be performed. As examples, optimizations may be performed for processes, as well as other activities of the intelligent workflow.

In one example, artificial intelligence agent 700 includes 750 the optimized benchmark(s) and/or other optimizations in the intelligent workflow.

Although examples of activities performed by the at least one artificial intelligence agent are provided, additional, fewer and/or other activities may be performed. Many variations are possible.

As described herein, to generate and execute an intelligent workflow and/or to provide dynamic workflows, at least one artificial intelligence agent is employed. As described, in one or more aspects, the at least one artificial intelligence agent is trained and retrained to continually learn to provide a dynamic and polymorphic intelligent workflow and/or dynamic workflows. The training/retraining trains the at least one artificial intelligence agent for the course of action defined for the entity. The at least one artificial intelligence agent may be provided and learn from input data associated with the course of action, including, but not limited to, components, processes, benchmarks and/or other information regarding the course of action and/or the entity. This input data is used in training the at least one artificial intelligence agent to be able to select appropriate data for analysis and make recommendations of changes to be made, as an example, to implement the dynamically changing course of action, including, but not limited to, optimizing a set of benchmarks, etc.

One or more aspects may use machine learning. For instance, machine learning may be used to train/retrain the at least one artificial intelligence agent, perform predictive modeling, perform optimization modeling, determine constraints/restrictions, learn from previous data/events, and/or perform other tasks. A system is trained to perform analyses and learn from input data and/or choices made.

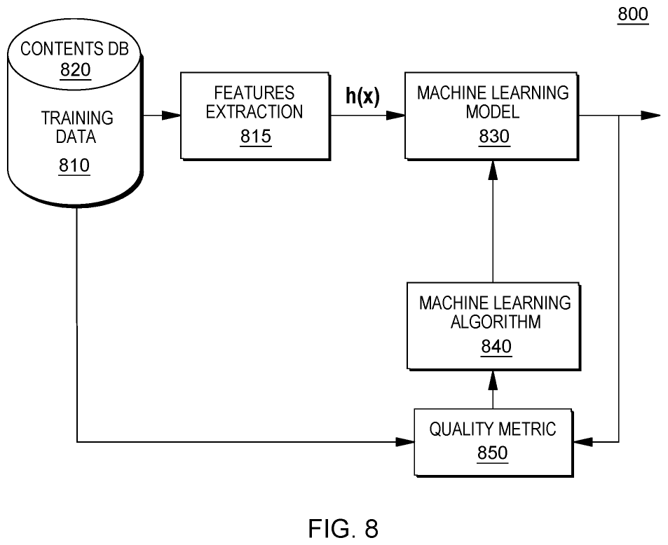

Referring to FIG. 8, in one or more aspects, a machine learning training system 800 may be utilized, in one or more aspects, to perform cognitive analyses of various inputs, including data from one or more sources, data repositories and/or other data. Training data utilized to train the model (e.g., of the at least one artificial intelligence agent) in one or more embodiments of the present disclosure includes, for instance, data obtained from exogenous sources, data relating to the entity, data related to execution of the benchmarks, data related to the dynamically changing course of action, etc. The program code in embodiments of the present disclosure performs a cognitive analysis to generate one or more training data structures, including algorithms utilized by the program code to predict states of a given event (e.g., changes in the course of action, changes to environmental conditions that may affect the course of action, changes to benchmarks, etc.). Machine learning solves problems that are not solved with numerical means alone. In this machine learning-based example, program code extracts various attributes from machine learning training data 810 (e.g., historical data collected from various data sources relevant to the event, exogenous data, other data, etc.), which may be resident in one or more databases 820 comprising event or task-related data and general data. Attributes 815 are utilized to develop a predictor function, h(x), also referred to as a hypothesis, which the program code utilizes as a machine learning model 830.

In identifying various event states, features, attribute similarities, constraints and/or behaviors indicative of states in the machine learning training data 810, the program code can utilize various techniques to identify attributes in an embodiment of the present disclosure. Embodiments of the present disclosure utilize varying techniques to select attributes (data attributes, elements, patterns, features, constraints, etc.), including but not limited to, diffusion mapping, principal component analysis, recursive feature elimination (a brute force approach to selecting attributes), and/or a Random Forest, to select the attributes related to various events. The program code may utilize a machine learning algorithm 840 to train the machine learning model 830 (e.g., a model for an artificial intelligence agent), including providing weights for the conclusions, so that the program code can train the predictor functions that comprise the machine learning model 830. The conclusions may be evaluated by a quality metric 850. By selecting a diverse set of machine learning training data 810, the program code trains the machine learning model 830 to identify and weight various attributes (e.g., data attributes, features, patterns, constraints, etc.) that correlate to various states of an event.

The model generated by the program code is self-learning as the program code updates the model based on active event feedback, as well as from the feedback received from data related to the event, exogenous data, etc. For example, when the program code determines that there is a condition or event that was not previously predicted by the model, the program code utilizes a learning agent to update the model to reflect the state of the event, in order to improve predictions in the future. Additionally, when the program code determines that a prediction is incorrect, either based on receiving user feedback through an interface or based on monitoring related to the event, the program code updates the model to reflect the inaccuracy of the prediction for the given period of time. Program code comprising a learning agent cognitively analyzes the data deviating from the modeled expectations and adjusts the model to increase the accuracy of the model, moving forward.

In one or more embodiments, program code, executing on one or more processors, utilizes an existing cognitive analysis tool or agent (now known or later developed) to tune the model, based on data obtained from one or more data sources. In one or more embodiments, the program code interfaces with application programming interfaces to perform a cognitive analysis of obtained data. Specifically, in one or more embodiments, certain application programming interfaces comprise a cognitive agent (e.g., learning agent) that includes one or more programs, including, but not limited to, natural language classifiers, a retrieve and rank service that can surface the most relevant information from a collection of documents, concepts/visual insights, trade off analytics, document conversion, and/or relationship extraction. In an embodiment, one or more programs analyze the data obtained by the program code across various sources utilizing one or more of a natural language classifier, retrieve and rank application programming interfaces, and trade off analytics application programming interfaces. An application programming interface can also provide audio related application programming interface services, in the event that the collected data includes audio, which can be utilized by the program code, including but not limited to natural language processing, text to speech capabilities, and/or translation.

In one or more embodiments, the program code utilizes generative artificial intelligence, large language models and/or a neural network to analyze event-related data to generate the model utilized to predict the state of a given event at a given time. Neural networks are biologically inspired programming paradigms which enable a computer to learn and solve artificial intelligence problems. This learning is referred to as deep learning, which is a subset of machine learning, an aspect of artificial intelligence, and includes a set of techniques for learning in neural networks. Neural networks, including modular neural networks, are capable of pattern recognition with speed, accuracy, and efficiency, in situations where data sets are multiple and expansive, including across a distributed network, including but not limited to, cloud computing systems. Modern neural networks are non-linear statistical data modeling tools. They are usually used to model complex relationships between inputs and outputs or to identify patterns (or similarities) in data (i.e., neural networks are non-linear statistical data modeling or decision making tools). In general, program code utilizing neural networks and/or other artificial intelligence techniques can model complex relationships between inputs and outputs and identify patterns in data. Because of the speed and efficiency of neural networks and/or other artificial intelligence techniques, especially when parsing multiple complex data sets, neural networks, other artificial intelligence techniques and deep learning provide solutions to many problems in multiple source processing, which the program code in one or more embodiments accomplishes when obtaining data and generating a model for predicting states of a given event.

As described herein, in one or more aspects, an intelligent workflow includes, for instance, at least one artificial intelligence agent to obtain data from, at least, exogenous sources, analyze the data, evaluate/re-evaluate benchmarks based on the data, and perform optimizations based thereon to keep pace with an ever-changing course of action. In one or more aspects, the entity and/or the course of action are considered holistically, in which, for instance, the entire course of action is evaluated rather than one specific component or activity.

One or more aspects of the present disclosure are tied to computer technology and facilitate processing within a computing device, improving performance thereof. For instance, data storage and retrieval are facilitated by accessing exogenous sources. System and data repositories are connected to streamline communication to facilitate retrieval and processing of data. By accessing exogenous sources, the data is maintained elsewhere. As a further example, processing within a computing device is improved by, for instance, using computer resources efficiently by dynamically making changes to, e.g., benchmarks and/or processes such that resources are not wasted in execution of benchmarks/processes no longer valid.

In one or more aspects, technical fields of computing, artificial intelligence and implementation of courses of action defined for entities are improved by facilitating the procurement and analysis of vast amounts of data, providing flexibility in implementation of the courses of action. Processing within a computing device, computer system and/or computing environment is improved by using computer resources efficiently by dynamically making changes to, e.g., benchmarks and/or processes such that resources are not wasted in execution of benchmarks/processes no longer valid.

Although various capabilities/activities of an intelligent workflow are described herein. In other embodiments, an intelligent workflow may include additional, fewer and/or other capabilities. The capabilities described herein are just examples.

In one particular example, an entity is an organization or a business, and a course of action is a business strategy. As one specific example, the business strategy is to increase profits by p % by increasing processing speed within a computing environment by x % and provide n new capabilities over y years at a total cost of z. A strategy or course of action is developed and is to be implemented. An initial set of benchmarks is determined, and an intelligent workflow is generated and executed in which at least one trained artificial intelligence agent repeatedly obtains data at selected times and re-evaluates the benchmarks. Based on, for instance, data obtained regarding new products, supply chain considerations, cost rates, technology, manufacturing deficiencies, other exogenous data and/or other data, etc., the at least one artificial intelligence agent determines that one or more benchmarks are to be deleted, one or more new benchmarks are to be added and one or more benchmarks are to be modified. This is based on a recognition by the at least one artificial intelligence agent that the strategy is dynamically changing based on the current information. By retrieving current data (including real-time data), evaluating the data (e.g., in real-time), and dynamically optimizing the benchmarks, improvements are made to the strategy, as well as to the computing devices used in implementing the strategy. For instance, the determination that certain benchmarks are to be deleted saves computing resources and storage by eliminating work that no longer needs to be performed. Other examples are possible.

Currently, business strategy models are static, point-in-time. They do not address the dynamicity of the marketplace, and each model is to be redone each time there is a change. However, in one or more aspects of the present disclosure, a strategy model is generated that continues to morph as one goes along (e.g., as there are changes to be addressed).

As an example, some companies change their strategy each time they do their financial modeling. This leads to de facto resetting the strategy every, e.g., six months or so when the companies redo their finances.

One or more aspects incorporate a time-based aspect into business strategy models, making the models less static, and thus, being able to accommodate any intelligent workflow driven changes.

Intelligent workflows can be used with a business strategy control model. Existing systems and methods to model business strategy do not take into consideration the dimension of time nor treat the strategy and business execution against the strategy as an intelligent workflow with constant re-evaluation of benchmarks with exogenous data.

One or more aspects take a business strategy model and use intelligent workflows which create, for instance, many (e.g., millions) of permutations based one or more optimizations. One or more aspects use intelligent workflows and take variables on how a business is run and have the intelligent workflow mediate so the strategy model understands what is working and what is not, and is able to react to it.

One or more aspects make the business strategy model time-conducive rather than point-in-time. One or more aspects add the element of time and manage the process as an intelligent workflow. One or more aspects allow the user to improve strategy models by including the element of time; track how well the strategy is progressing given current market and business conditions, improve the strategy and avoid strategic issues of the past; measure and monitor and continuously evaluate benchmarks+strategy+execution to discern if the benchmarks are still valid; and feedback alterations to benchmarks+strategy+execution and provide course corrective action to achieve business outcomes. Although in one or more aspects continuous or continual evaluation and/or optimization are described as examples, in other examples, the evaluation and/or optimization are performed repeatedly, which may be continuous or continual, or may be at selected times, periodically, at fixed intervals, at certain times based on signals indicating one or more defined changes, based on events germane to the execution transpiring, based on a schedule, etc. Many examples are possible.

In one or more aspects, a method, system and computer program product for continuously optimizing benchmarks for business strategies of a business are provided. The method, system and computer program product include, for instance: determining an initial set of benchmarks and how each benchmark sits in relation to components of a business strategy, wherein each benchmark is required to guide execution of the components over time; optimizing (e.g., improving/updating/changing/adding/pulling back/maintaining) the initial set of benchmarks at future points in time by periodically re-evaluating the benchmarks using new data gathered from exogenous data sources and evaluating the new data using an artificial intelligence and time-based algorithm, wherein the new data is associated with current market conditions, skill levels, current state of technology, affordability, and/or news stories; outputting an optimized set of benchmarks after each periodic optimization; and utilizing the initial set of benchmarks and optimized set of benchmarks in future periodic re-evaluations of the benchmarks wherein the re-evaluations take into account temporal factors for each previous set of benchmarks.

One or more aspects build on strategy roadmaps by incorporating the element of time; track how well the strategy is progressing; improve the strategy and avoid strategic issues of the past; measure & monitor: benchmark+strategy+execution. One or more aspects enable a business to offer strategy as-a-service. In one or more aspects, capacity is extended to do strategy engagement long term over a life cycle which will cause growth in that type of strategy work. One or more aspects include sustainability and security business opportunities. One or more aspects position a business as incumbents instead of getting pieces of work.

In one or more aspects, the following are placed into one intelligent workflow: backtest the model, issues of the past, lessons learned, feedback loop; temporal, traceable, dynamic relationships; repeated evaluation of benchmarks to obtain dynamic benchmarks; identify business processes that in their execution-expose deficiencies in the resiliency, redundancy, etc.; and measure & monitor against benchmark+strategy+execution—possible single points of failure.

One or more aspects provide an all in one intelligent workflow: strategy over time-within the same model; multi-dynamic recursive pathway identifier; take existing pathways and evaluate in current and future models.

As part of the intelligent workflow:
Backtest the model; issues of the past; lessons learned; feedback loop:

Intelligent workflows break an entity's (e.g., business') strategy by creating the space for dynamic alterations that are not constrained by firm, immutable rules. Different pathways can be explored to achieve better results. The dynamic composition is what causes this. An intelligent workflow allows an entity to do permutations never tried to process a model in if-then-else. Now, new behaviors and activities are being exhibited where the activities and rules of assembly are known, as well as different pathways and benchmarks. If the benchmarks are off, then the strategy is off.

Historical data is leveraged to backtest the model, capture lessons learned and be used in a feedback loop.

### Historical+Market+

Leverage historical data to predict the future.
Allows for anti-bias assessment against the sunk-cost fallacy by reviewing the combination of the benchmarks+strategy+execution.
Evaluation of change management success; wasted motion analysis; how many components were impacted at once; entity had a great strategy but was it too complex to be sustainable?
Evaluation of permutations that may break the predicted business outcomes.
Evaluation of repeatable execution.

History is preserved and learn from issues of the past providing visibility into relationships. Relationships going back are assessed and there is a record of the differences. Can compare delta that did not know before. Benchmark strategy is compared against execution results.

At execute level—that's where the intelligent workflow lives, usually. This is at the strategy level. Improvement to management level and exceptional improvement to strategy and direction level.
Methodology—Temporal, traceable, dynamic relationships:

One or more aspects enable tracing, comparing and modeling of relationships evolving over time. That is, there is traceability across relationships and over time, including historical traceability. Tracing can be performed from different points and compared in time. The infection points can be seen where the relationships between business entities have changed over time. That is, for example, the set of benchmarks, processes and changes made to each over time. As the relationships change between business entities, one or more aspects show how the strategy has influenced and been influenced by those changing relationships. Traceability, transparency and explainability (how artificial intelligence derived the result/output) are preserved by tracking the execution against the benchmarks and tracing the course corrections and optimizations to the benchmarks over time. This is also fed back, in one example, into the artificial intelligence training model for subsequent optimizations.

Now have something foundational that allows an entity to perform the tracing, comparing and modeling of relationships evolving over time.

One or more aspects dynamically create one or more benchmarks and identify items that could be benchmarks. This provides an expansion of what could be a benchmark.

The ability to trace and compare relationships has been added, in one or more aspects.

Method: have capacity to have the data available and a machine that says: “What is the growth pattern?”

Points in time—as the relationships change in the strategy—it can be seen how to get there.

A to-be model says need to change a-m, and then tinker with those, and can predict whether the to-be will be reached.

Incrementally make changes—will it affect what currently have.
Continuously evaluate benchmarks:

A strategy is to evolve as the underlying assumptions and business environment changes. One or more aspects of the present disclosure provide for the separation of strategy, and evaluation of the appropriateness of the strategy. The comparison for how the operational execution adheres to the strategy allows for process improvements and execution course corrections. Keeping these elements separate from one another allows for a controlled evaluation of whether the strategy or the execution is to individually be changed, or whether both are to change given the evolution of new input over time. Following classical scientific method of testing, the hypothesis and determining whether the observed conditions prove or refute the hypothesis allows for the continual evaluation of one or more benchmarks. Using artificial intelligence/machine learning techniques provides for a reduction in bias and potential lack of imagination and understanding that the improbable cannot be discounted.

In one or more aspects, the continuous revisiting, qualifying and evaluating the initial benchmarks allow one to validate the initial hypothesis that the benchmarks are the correct ones. The strategy is to condition itself to reflect upon changing benchmarks. The initial benchmarks will evolve over time due to changing conditions, some of which were not predictable at the start. By repeatedly reviewing the applicability and appropriateness of the relevant benchmarks, strategy and therefore the process execution may be dynamically adapted. Rejecting benchmarks because they have proven not to be applicable to the strategy allows for the process to improve faster since the distraction of these incorrect benchmarks are eliminated. Additional or substitute benchmarks are identified and included in the evaluation of the success of the strategy. These new benchmarks provide the opportunity to improve the process outcomes and increase the speed at which the process can improve. A benchmark is dynamically created, and items are identified that can be a benchmark. Whitespace is located: benchmarks that may be in a different industry or context but can prove to be useful. By ingesting exogenous data from a variety of sources, including examples such as feeds, social network sites, etc., one or more aspects allow for dynamic analysis against the assumptions and hypothesis that form the baseline for the strategy and suggest execution improvements to more closely adhere to the changing nature of the business environment. This is further enhanced via foundation models/large language models and generative artificial intelligence among other artificial intelligence models and techniques. Many variations are possible.

In one or more aspects, do not consider a benchmark to be static. Enhancements in business, technology, market conditions, legal, environmental considerations can all change a benchmark. Consider the possibility that an inappropriate benchmark was initially chosen. Pivot execution to realize a more optimal path. Find whitespace—these same characteristics are addressing benchmarks like this in other companies “It's kind of like.” These benchmarks apply to this industry and x of them apply to that industry so maybe should be looking at that. The artificial intelligence agent quickly assesses such relationships and applicability to the current entity faster and effectively than a human.
Identify business processes that in their execution-expose deficiencies in the resiliency, redundancy, etc.:

One or more aspects of the present disclosure take into account the transformation activities in flight from a temporal perspective. The benchmarks are used as hypotheses for what is to be achieved. As the process transformation takes place in an iterative manner, the constant comparison against those benchmarks identify and expose areas where additional improvements in speed and cost are. This is highly correlated with the constant evaluation of the benchmarks, since when a benchmark is proved to be less valuable than initially thought, removing the benchmark and substituting it with a more appropriate one will spur improved activity. Scientific methodology suggests that all manner of evaluation outcomes are possible as the hypotheses are exercised via simulation, regression or other testing means—not just outright rejection of a benchmark, but also evolution of portions of the data or new exogenous data sources to further reinforce the impact of one benchmark over another.

Additionally, consideration is given to how ecosystem networks operate, which can be n-levels deep. Rarely, does an entity control all elements of supply and demand, and process change at one level in the hierarchy can have an impact on several levels higher or lower. This understanding of the processes that are impacted by the strategy are further evaluated against the benchmarks on a continual basis, and through the iterative evolution of the strategy, new and different options may emerge that will have a more significant impact in terms of speed, cost or other measurable outcomes. Furthermore, in one or more aspects, executing simulations for resiliency and redundancy makes for a more sustainable process in the long term, and the elements outlined herein can be applied in the same manner to optimize for those process outcomes.

In one or more aspects, process analysis is performed—Evaluate whether developers are reusing code, working efficiently. Ensure programmers are using the right patterns when developing. For example, use this sort algorithm, do not write your own. Does the payroll practice do things others do not do.

Look different from industry? Leverage benchmark analysis; highlight where a benchmark thought to be good and firm but actually is not. Compare benchmarks to oneself, change over time, competitors, other businesses doing similar things. N levels deep in supply chain, business process.
Measure & monitor against benchmark+strategy+execution—Possible single points of failure:

This is highly correlated with the constant evaluation of the benchmarks, since when a benchmark is proven to be less valuable than initially thought, removing the benchmark and substituting it with a more appropriate one will spur improved activity.

Scientific method suggests that all manner of evaluation outcomes are possible as the hypotheses are exercised via simulation, regression or other testing means—not just outright rejection of a benchmark, but also evolution of portions of the data or new exogenous data sources to further reinforce the impact of one benchmark over another.

Known business models may be used to model, analyze, and strategize.

One example of a temporal profiling algorithm for benchmark optimization includes:

Benchmark optimization for each business strategy component. Benchmark profiling for optimum impact is based on, e.g.: market/domain evolution; technology evolution; and domain complexity weightage.

The model (e.g., of an artificial intelligence agent) suggests most appropriate time based optimization to be used for each business strategy component; i.e., evaluate benchmark for current suitability & fitness (Business strategy element): H1—50%, H2—40%, H3—10%, where H is time horizon and H1 is an immediate time, H2 is in the future and H3 is further in the future.

For each benchmark of the business strategy map, the following are input features:
Market/Domain Evolution: Process <<mapped process>>; Benchmark <<benchmark 1, 2, n>>.
Domain Complexity: Market/Domain Evolution speed factor <<calculate based on how fast emerging industry force is adopted >>; Domain Complexity <<assume available>>.
Technology Evolution Factor: Technology evolution factor <<calculate based on how fast emerging technology is adopted>>; Cost/Revenue <<assume available>>.

For each benchmark of the business strategy map, have, for instance, the following parametrization and influence input features: Horizon-<<available from model>>; Execution results <<key performance indicators, key business outcomes, etc. >>; Speed of execution <<assume available>>; Avg Cost <<assume available>>; Risk level <<assume available>>; Complexity <<assume available>>; Other <<assume available>>.

Optimize set of benchmarks for applicability, given current parameters and influence features, such as market conditions, current state of the art technology, affordability, but not limited to the above.

Model to forecast sparse benchmark for optimum applicability levels: Model is trained as a multi-class classifier, taking in as features categories from, e.g.: Time Horizon distribution {H1 [30%], H2 [50%], H3 [20%]}—Expert Cost, speed and quality; TLs (time lines) Cost, speed and quality; Avg Cost, speed and quality.

The model (e.g., of the artificial intelligence agent) suggests most appropriate benchmark(s) to be used for each time slice distribution; i.e., evaluate benchmark (Business Strategy Element): H1—50% [TL-10, Exp—30, Avg—60], H2—40% [TL-10, Exp—30, Avg-60], H3—10% [TL-10, Exp—30, Avg—60], where Exp is explainability and avg is average. Yields enhanced set of benchmarks to guide business strategy execution and decision making. This is an example of how weighting strategies across time horizons may be employed. Many such models are possible.

One or more aspects provide an intelligent workflow that repeatedly (e.g., at selected times, periodically, at fixed intervals, at certain times based on signals indicating one or more defined changes, based on events germane to the execution transpiring, based on a schedule, continuously, continually, etc.) re-evaluates benchmarks used to guide implementation of a course of action defined for an entity (e.g., a business strategy). Re-evaluation is based on a vast amount of obtained data, such as exogenous data from a variety of sources. The re-evaluation is performed by at least one artificial intelligence agent that is able to evaluate extremely large amounts of data and consider many (even millions) of permutations.

In one or more aspects, manual efforts, relying on expert skills of people with time constraints and whose skills and talents are not easily documented and shared, are avoided. One or more aspects provide an intelligent workflow that allows practitioners to act with the experience of the best practitioners, whose expertise and insight are aggregated in a digital repository, avoiding human error and increasing the speed and possibilities to be evaluated. Using artificial intelligence increases the likelihood that pertinent information will be found, since constant market, business and news scanning for opportunities, weaknesses and potential problems is a time-consuming effort in which the most salient information can be easily missed by humans. By evaluating benchmarks repeatedly to determine their relevancy, instead of treating them statically, enables the dynamicity of current conditions evaluated against the benchmarks, thus, refreshing the parameters.

Other aspects, variations and/or embodiments are possible.

One or more aspects of the present disclosure may be used with many types of environments. The computing environments provided herein are only examples. Each computing environment is capable of being configured to include one or more aspects of the present disclosure. For instance, each may be configured to provide an intelligent workflow, provide dynamic benchmarks and/or to perform to one or more other aspects of the present disclosure.

In addition to the above, one or more aspects may be provided, offered, deployed, managed, serviced, etc. by a service manager who offers management of customer environments. For instance, the service manager can create, maintain, support, etc. computer code and/or a computer infrastructure that performs one or more aspects for one or more customers. In return, the service manager may receive payment from the customer under a subscription and/or fee agreement, as examples. Additionally, or alternatively, the service manager may receive payment from the sale of advertising content to one or more third parties.

In one aspect, an application may be deployed for performing one or more embodiments. As one example, the deploying of an application comprises providing computer infrastructure operable to perform one or more embodiments.

As a further aspect, a computing infrastructure may be deployed comprising integrating computer readable code into a computing system, in which the code in combination with the computing system is capable of performing one or more embodiments.

As yet a further aspect, a process for integrating computing infrastructure comprising integrating computer readable code into a computer system may be provided. The computer system comprises a computer readable medium, in which the computer medium comprises one or more embodiments. The code in combination with the computer system is capable of performing one or more embodiments.

Although various embodiments are described above, these are only examples. For example, other data sources may be used, other activities may be considered and/or other actions may be taken. Further, many example courses of action may be implemented and/or other types of entities may be considered. Many variations are possible.

Various aspects and embodiments are described herein. Further, many variations are possible without departing from a spirit of aspects of the present disclosure. It should be noted that, unless otherwise inconsistent, each aspect or feature described and/or claimed herein, and variants thereof, may be combinable with any other aspect or feature.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components and/or groups thereof.

The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description but is not intended to be exhaustive or limited to in the form disclosed. Many modifications and variations will be apparent to those of ordinary skill in the art. The embodiment was chosen and described in order to best explain various aspects and the practical application, and to enable others of ordinary skill in the art to understand various embodiments with various modifications as are suited to the particular use contemplated.

What is claimed is:

1. A computer-implemented method of dynamic processing within a computing environment, the computer-implemented method comprising:
determining a set of benchmarks for a course of action defined for an entity;
obtaining data from one or more exogenous sources relating to environmental conditions;
evaluating, using at least one artificial intelligence agent executing on at least one computing device of the computing environment, one or more benchmarks of the set of benchmarks based, at least, on the data obtained from the one or more exogenous sources;
optimizing, using the at least one artificial intelligence agent, the set of benchmarks, based on the evaluating the one or more benchmarks, to obtain a revised set of benchmarks;
outputting the revised set of benchmarks to be used to evaluate one or more components of the course of action defined for the entity; and
repeating the obtaining, the evaluating, the optimizing and the outputting at a plurality of selected times to optimize the revised set of benchmarks, wherein the set of benchmarks for the repeating is the revised set of benchmarks, and wherein the revised set of benchmarks dynamically change over the plurality of selected times as the course of action evolves over time.

2. The computer-implemented method of claim 1, wherein the at least one artificial intelligence agent is trained for the course of action defined for the entity.

3. The computer-implemented method of claim 2, further comprising retraining the at least one artificial intelligence agent based on feedback relating to the set of benchmarks.

4. The computer-implemented method of claim 1, wherein a benchmark is used to measure effectiveness of a component of the one or more components of the course of action, the component including one or more tasks to be performed to implement the course of action defined for the entity.

5. The computer-implemented method of claim 1, wherein the obtaining data from the one or more exogenous sources comprises retrieving, via one or more communication networks, data relating to one or more current exogenous conditions.

6. The computer-implemented method of claim 1, wherein the optimizing the set of benchmarks comprises adding a new benchmark to the set of benchmarks.

7. The computer-implemented method of claim 1, wherein the optimizing the set of benchmarks comprises deleting a benchmark from the set of benchmarks.

8. The computer-implemented method of claim 1, wherein the optimizing the set of benchmarks comprises modifying a benchmark of the set of benchmarks.

9. The computer-implemented method of claim 1, wherein the obtaining the data, the evaluating the one or more benchmarks, and the optimizing the set of benchmarks are executed as part of an intelligent workflow generated to implement the course of action defined for the entity.

10. The computer-implemented method of claim 1, further comprising:
performing analysis, using the at least one artificial intelligence agent, to identify deficiencies in one or more processes of the entity; and
providing, using the at least one artificial intelligence agent, one or more modifications to the one or more processes to improve use of resources of the entity.

11. The computer-implemented method of claim 10, wherein the resources of the entity include computer resources of the entity, and wherein the one or more modifications improve processing speed within one or more computing devices of the computing environment.

12. The computer-implemented method of claim 10, wherein the obtaining the data, the evaluating the one or more benchmarks, the optimizing the set of benchmarks, the performing analysis and the providing the one or more modifications are executed as part of an intelligent workflow generated to implement the course of action defined for the entity.

13. The computer-implemented method of claim 1, further comprises obtaining historical data relating to the course of action defined for the entity, and wherein the evaluating uses the historical data and the data obtained from the one or more exogenous sources.

14. A computer system for dynamic processing within a computing environment, the computer system comprising:
a memory; and
one or more computing devices in communication with the memory, wherein the computer system is configured to perform a method, said method comprising:
determining a set of benchmarks for a course of action defined for an entity;
obtaining data from one or more exogenous sources relating to environmental conditions;
evaluating, using at least one artificial intelligence agent executing on at least one computing device of the computing environment, one or more benchmarks of the set of benchmarks based, at least, on the data obtained from the one or more exogenous sources;
optimizing, using the at least one artificial intelligence agent, the set of benchmarks, based on the evaluating the one or more benchmarks, to obtain a revised set of benchmarks;
outputting the revised set of benchmarks to be used to evaluate one or more components of the course of action defined for the entity; and
repeating the obtaining, the evaluating, the optimizing and the outputting at a plurality of selected times to optimize the revised set of benchmarks, wherein the set of benchmarks for the repeating is the revised set of benchmarks, and wherein the revised set of benchmarks dynamically change over the plurality of selected times as the course of action evolves over time.

15. The computer system of claim 14, wherein the obtaining the data, the evaluating the one or more benchmarks, and the optimizing the set of benchmarks are executed as part of an intelligent workflow generated to implement the course of action defined for the entity.

16. The computer system of claim 14, wherein the method further comprises:
performing analysis, using the at least one artificial intelligence agent, to identify deficiencies in one or more processes of the entity; and
providing, using the at least one artificial intelligence agent, one or more modifications to the one or more processes to improve use of resources of the entity.

17. A computer program product for facilitating processing within a computing environment, the computer program product comprising:
one or more computer readable storage media and program instructions collectively stored on the one or more computer readable storage media readable by at least one processing circuit to:
determine a set of benchmarks for a course of action defined for an entity;
obtain data from one or more exogenous sources relating to environmental conditions;
evaluate, using at least one artificial intelligence agent executing on at least one computing device of the computing environment, one or more benchmarks of the set of benchmarks based, at least, on the data obtained from the one or more exogenous sources;
optimize, using the at least one artificial intelligence agent, the set of benchmarks, based on the evaluating the one or more benchmarks, to obtain a revised set of benchmarks;
output the revised set of benchmarks to be used to evaluate one or more components of the course of action defined for the entity; and
repeat obtaining, evaluating, optimizing and outputting at a plurality of selected times to optimize the revised set of benchmarks, wherein the set of benchmarks for the repeating is the revised set of benchmarks, and wherein the revised set of benchmarks dynamically change over the plurality of selected times as the course of action evolves over time.

18. The computer program product of claim 17, wherein the program instructions readable by the at least one processing circuit to obtain the data, evaluate the one or more benchmarks, and optimize the set of benchmarks are executed as part of an intelligent workflow generated to implement the course of action defined for the entity.

19. The computer program product of claim 17, wherein the program instructions are further readable by the at least one processing circuit to:
perform analysis, using the at least one artificial intelligence agent, to identify deficiencies in one or more processes of the entity; and
provide, using the at least one artificial intelligence agent, one or more modifications to the one or more processes to improve use of resources of the entity.

20. The computer program product of claim 17, wherein the program instructions are further readable by the at least one processing circuit to obtain historical data relating to the course of action defined for the entity, and wherein the program instructions readable by the at least one processing circuit to evaluate further include program instructions readable by the at least one processing circuit to use the historical data and the data obtained from the one or more exogenous sources.

21. A computer-implemented method of dynamic processing within a computing environment, the computer-implemented method comprising:
executing an intelligent workflow to implement a course of action defined for an entity, wherein the executing comprises:
determining a set of benchmarks for the course of action defined for the entity;
obtaining data to be used in evaluating the set of benchmarks;
evaluating, using at least one artificial intelligence agent executing on at least one computing device of the computing environment, one or more benchmarks of the set of benchmarks based, at least, on the data obtained from the one or more exogenous sources;
optimizing, using the at least one artificial intelligence agent, the set of benchmarks, based on the evaluating the one or more benchmarks, to obtain a revised set of benchmarks;
outputting the revised set of benchmarks to be used to evaluate one or more components of the course of action defined for the entity; and
repeating the obtaining, the evaluating, the optimizing and the outputting at a plurality of selected times to optimize the revised set of benchmarks, wherein the set of benchmarks for the repeating is the revised set of benchmarks, and wherein the revised set of benchmarks dynamically change over the plurality of selected times as the course of action evolves over time.

22. The computer-implemented method of claim 21, wherein the executing further comprises:
performing analysis, using the at least one artificial intelligence agent, to identify deficiencies in one or more processes of the entity; and
providing, using the at least one artificial intelligence agent, one or more modifications to the one or more processes to improve use of resources of the entity.

23. The computer-implemented method of claim 22, wherein the executing further comprises:
obtaining feedback relating to implementation of the course of action; and
performing one or more actions based on the feedback to revise the intelligent workflow.

24. The computer-implemented method of claim 23, wherein the performing the one or more actions comprises optimizing the set of benchmarks.

25. A computer program product for facilitating processing within a computing environment, the computer program product comprising:
one or more computer readable storage media and program instructions collectively stored on the one or more computer readable storage media readable by at least one processing circuit to:
execute an intelligent workflow to implement a course of action defined for an entity, wherein execution of the intelligent workflow includes:
determining a set of benchmarks for the course of action defined for the entity;
obtaining data to be used in evaluating the set of benchmarks;
evaluating, using at least one artificial intelligence agent executing on at least one computing device of the computing environment, one or more benchmarks of the set of benchmarks based, at least, on the data obtained from the one or more exogenous sources;
optimizing, using the at least one artificial intelligence agent, the set of benchmarks, based on the evaluating the one or more benchmarks, to obtain a revised set of benchmarks;
outputting the revised set of benchmarks to be used to evaluate one or more components of the course of action defined for the entity; and
repeating the obtaining, the evaluating, the optimizing and the outputting at a plurality of selected times to optimize the revised set of benchmarks, wherein the set of benchmarks for the repeating is the revised set of benchmarks, and wherein the revised set of benchmarks dynamically change over the plurality of selected times as the course of action evolves over time.
